(19) United States
(12) Patent Application Publication
(10) Pub. No.: US 2011/0048247 A1
(43) Pub. Date: Mar. 3, 2011

(54) AUTOMATIC BREAD MAKER

(75) Inventors: Teruaki Taguchi, Tottori City (JP); Toshiharu Fujiwara, Tottori City (JP); Yoshinari Shirai, Tottori City (JP); Masao Hayase, Tottori City (JP); Masayuki Shimozawa, Tottori City (JP); Takashi Watanabe, Tottori City (JP); Yasuyuki Ito, Tottori City (JP); Kazuya Yano, Tottori City (JP)

(73) Assignees: SANYO ELECTRIC CO., LTD.; SANYO CONSUMER ELECTRONICS CO., LTD.

(21) Appl. No.: 12/834,536

(22) Filed: Jul. 12, 2010

(30) Foreign Application Priority Data
Sep. 2, 2009 (JP) 2009-202230
Sep. 2, 2009 (JP) 2009-202585

(51) Int. Cl. A21B 7/00

(52) U.S. Cl. 99/348

(57) ABSTRACT

Provided is an automatic bread maker which sequentially performs a mixing/kneading process, a fermentation process, and a baking process, the automatic bread maker including: a bread container used for accommodating breadmaking materials; a baking chamber which is provided inside a body and receives the bread container; a grinding blade which is capable of being put in and taken out of the bread container in the baking chamber; and a grinding motor provided for rotating the grinding blade.

This application is based on Japanese Patent Application No. 2009-202230 filed on Sep. 2, 2009, and Japanese Patent Application No. 2009-202585 filed on Sep. 2, 2009, and the contents of which are hereby incorporated by reference.

### BACKGROUND OF THE INVENTION

1. Field of the Invention

The present invention relates to an automatic bread maker mainly for household use.

2. Description of Related Art

An automatic bread maker commercially available for household use generally works as follows. That is, a bread container containing breadmaking materials are installed into a baking chamber inside a body, and the breadmaking materials in the bread container are mixed and kneaded with a mixing/kneading blade to be turned into dough. The dough is then subjected to a fermentation process. After that, the dough is baked to make bread using the bread container as a bread pan. Japanese Patent Application Laid-open No. 2000-116526 discloses an example of the automatic bread maker.

The breadmaking materials may also be mixed with fillings such as raisins and nuts to bake bread with such fillings. Japanese Patent No. 3191645 discloses an automatic bread maker provided with a device for automatically feeding sub-materials, such as raisins, nuts, and cheese, for breadmaking.

Meanwhile, rice flour bread made by using rice flour is unique in texture, and in demand different from that for wheat bread. A conventional automatic bread maker is intended for making bread by using wheat flour as a main raw material therefor. When the conventional automatic bread maker is used to make bread by using rice flour as a main raw material therefor, rice flour bread cannot be made fluffy if the same process for making bread by using wheat flour as a main raw material therefor is used because rice flour is different from wheat flour in moisture content and has the properties for releasing moisture over time.

In order to solve the problem, there is proposed an automatic bread maker, in which a degassing process for promoting the activity of yeast, which is one of the breadmaking processes, is omitted, to thereby reduce time it takes to make bread (see Japanese Patent Application Laid-open No. 2004-255163). According to Japanese Patent Application Laid-open No. 2004-255163, moisture release from the rice flour may be suppressed, and hence the bread may be made fluffy even in a case where rice flour is used as a main raw material for the bread.

[Patent Document 1] JP 2000-116526 A

[Patent Document 2] JP 3191645 B

[Patent Document 3] JP 2004-255163 A

### SUMMARY OF THE INVENTION

When making bread, heretofore, flour made from cereals such as wheat and rice, or a mix of the flour and various auxiliary materials should be prepared at first. Even if there are cereal grains in hand (rice grains are typical therefor), it has been difficult to make bread directly therefrom. Further, most of commercially available rice flour, which have been conventionally used for making bread, is made from rice which is relatively high in rice milling rate, and the rice milling rate cannot be selected. However, coupled with rising concern for health in recent years, it is desired that the rice milling rate be made freely selectable from white rice to brown rice as the raw material for the bread from various viewpoints in terms of, for example, nutritional value, taste, color, and appearance.

The present invention has been made in view of the above-mentioned problems, and therefore, it is an object of the present invention to provide an automatic bread maker which has a mechanism convenient for making bread from grains (cereal grains) without going through a flour preparation process, to thereby make breadmaking more familiar.

In order to achieve the above-mentioned object, according to the present invention, an automatic bread maker which sequentially performs a mixing/kneading process, a fermentation process, and a baking process, includes: a bread container used for accommodating breadmaking materials; a baking chamber which is provided inside a body and receives the bread container; a grinding blade which is capable of being put into and taken out of the bread container in the baking chamber; and a grinding motor provided for rotating the grinding blade.

With this configuration, grains are put into the bread container and the grains are ground by the grinding blade. Therefore, breadmaking materials are prepared inside the bread container. Then, the ground grains are directly used for making bread inside the bread container, without a loss of the ground grains, which may otherwise be suffered when the grains are ground in another container and transferred into the bread container (the loss refers to residual ground grains in the another container without being transferred into the bread container). Further, in and after the mixing/kneading process, the grinding blade may be removed from the bread container, and hence the bread may be baked without being distracted by the grinding blade.

Further, according to the present invention, the automatic bread maker with the above-mentioned configuration further includes a lid for covering the baking chamber, and in a state in which the bread container is disposed inside the baking chamber and the baking chamber is covered with the lid, the grinding blade is provided to a tip end of a rotation shaft hanging down inside the bread container from the lid.

In the automatic bread maker with the above-mentioned configuration, a sheathing may be provided, which surrounds the rotation shaft and the grinding blade. With this configuration, a risk of injury to the fingers due to contact with the rotation shaft and the grinding blade may be reduced.

Further, in the automatic bread maker with the above-mentioned configuration, the sheathing is bulged at a portion surrounding the grinding blade, and the bulged portion may have an inner surface formed in a concavo-convex shape for preventing a flow of food. With this configuration, the sheathing may form a protection space corresponding to an area occupied by the rotation shaft and the grinding blade. Further, the concavo-convex shape may suppress the flow of the food, to thereby promote the grinding.

Further, in the automatic bread maker with the above-mentioned configuration, the sheathing may preferably have an air vent hole formed in the bulged portion. With this configuration, air does not build up inside the bulged portion, and hence entry of the food into the bulged portion may not be inhibited by air, with the result that the grinding may be performed reliably.

In the automatic bread maker with the above-mentioned configuration, the grinding motor, which rotates the rotation shaft, may be incorporated in a motor case which is insertable into the lid from above, and the rotation shaft and the grinding blade may hang down from a lower surface of the motor case, and may be capable of being pulled out, along with the motor case, from the lid.

With this configuration, the rotation shaft and the grinding blade are pulled out from the lid together with the motor case after grinding grains in the bread container, so that the mixing/kneading process may be performed without being distracted by the rotation shaft and the grinding blade.

Further, in the automatic bread maker with the above-mentioned configuration, the grinding motor, which rotates the rotation shaft, may be incorporated in the lid, and the rotation shaft and the grinding blade may form a grinding blade assembly, which may be coupled to the grinding motor in a detachable manner.

With this configuration, the grinding blade assembly may be detached from the motor after grinding grains in the bread container, so that the mixing/kneading process may be performed without being distracted by the grinding blade assembly.

In the automatic bread maker with the above-mentioned configuration, it is preferred that the lid is capable of being lifted up from the body and turned in a lift up state. With this configuration, the lid is turned (to an open position) in the lift up state, so that the grinding blade assembly may be attached to and detached from the motor in a horizontal position. Accordingly, the grinding blade assembly may be attached and detached with ease.

Further, according to the present invention, the automatic bread maker with the above-mentioned configuration further includes: a rotation shaft provided with the grinding blade at a lower end thereof; and a mixing kneader surrounding the grinding blade and the rotation shaft, and in a state in which the bread container is disposed inside the baking chamber, the rotation shaft and the mixing kneader hang down inside the bread container from above.

With this configuration, the rotation shaft and the grinding blade are surrounded by the mixing kneader, and hence the risk of injury to the fingers due to contact with the rotation shaft and the grinding blade may be reduced. Further, the grinding blade and the mixing kneader are disposed inside the bread container as hanging down from the above, rather than being provided to the bread container, and hence the bread container may be simplified in configuration.

In the automatic bread maker with the above-mentioned configuration, it is preferred that the mixing kneader include a dough kneading part in a dorm shape surrounding the grinding blade and a dough turning part in a form of a rotational body provided above the dough kneading part. When the dough is kneaded by the dough kneading part in the dorm shape surrounding the grinding blade, the dough tends to make its way upward. The dough moving upward is held back by the dough turning part above the dough kneading part, and hence the dough may be kept to the dough kneading part. Accordingly, the dough may be kneaded sufficiently.

In the automatic bread maker with the above-mentioned configuration, the mixing kneader may preferably be provided with a plurality of kneading arms projecting in radial directions, between the dough kneading part and the dough turning part. With this configuration, the kneading arms catch the dough, so that the dough is made to reliably follow the movement of the mixing kneader, and hence the dough may be kneaded sufficiently.

In the automatic bread maker with the above-mentioned configuration, the rotation shaft and the mixing kneader may be separately rotated by different motors. With this configuration, a high-speed rotation required for the grinding blade and a low-speed and high-torque rotation required for the mixing kneader may be implemented without effort.

In the automatic bread maker with the above-mentioned configuration, it is preferred that a lifting part for supporting the rotation shaft and the mixing kneader be further included inside the automatic bread maker, and the lifting part move up and down, to thereby allow the rotation shaft and the mixing kneader to be alternately switched between a state in which the rotation shaft and the mixing kneader are disposed inside the bread container and a state in which the rotation shaft and the mixing kneader are pulled out from the bread container.

With this configuration, there may be easily achieved a state in which the grinding blade (provided at a lower end of the rotation shaft) and the mixing kneader are disposed inside the bread container in the baking chamber, and a state in which the grinding blade and the mixing kneader are pulled out therefrom. Further, in this configuration, the rotation shaft and the mixing kneader may be preferably pulled out from the bread container, prior to baking bread. In this manner, bread with no trace of the rotation shaft, the grinding blade, and the mixing kneader may be baked.

Further, according to the present invention, the automatic bread maker with the above-mentioned configuration further includes: a rotation shaft which is provided with the grinding blade at a lower end thereof and hangs down from above the baking chamber; and a lifting part for moving up the bread container in the baking chamber to a grinding position where the grinding blade is brought close to a bottom of the bread container.

With this configuration, the bread container containing grains is lifted up by the lifting part so that the grains are ground by the grinding blade waiting above, to thereby prepare breadmaking material inside the bread container. The bread container containing the grains thus ground is brought down to be placed at the bottom of the baking chamber, so that the ground grains are directly used for baking bread inside the bread container.

In the automatic bread maker with the above-mentioned configuration, a sheathing may be provided, which surrounds the rotation shaft and the grinding blade. With this configuration, the risk of injury to the fingers due to contact with the rotation shaft and the grinding blade may be reduced.

In the automatic bread maker with the above-mentioned configuration, it is preferred that the bread container have a mixing/kneading blade disposed at the bottom thereof, and the baking chamber have a driving shaft disposed at a bottom thereof, the driving shaft being coupled to the mixing/kneading blade when the bread container is disposed at the bottom of the baking chamber. With this configuration, a series of breadmaking process from the process of grinding grains to the process of baking of bread may be performed seamlessly in the bread container placed inside the automatic bread maker.

Further, according to the present invention, the automatic bread maker with the above-mentioned configuration further includes: a rotation shaft provided with the grinding blade at one end thereof; and a lifting part for supporting the grinding motor and the rotation shaft, and the lifting part moves up and down, to thereby allow the grinding blade and the rotation shaft to be alternately moved to a grinding position where the grinding blade is brought close to the bottom of the bread container disposed in the baking chamber and a retraction position where the grinding blade is retracted outside the bread container disposed in the baking chamber.

With this configuration, the grinding blade is brought down into the bread container containing grains, to thereby grind the grains. In this manner, the breadmaking material is prepared inside the bread container and the breadmaking material thus prepared is directly used for baking bread inside the bread container.

In the automatic bread maker with the above-mentioned configuration, the lifting part may move up and down in a vertical direction, and the rotation shaft may be placed in a horizontal direction as being in the retraction position. With this configuration, the automatic bread maker may be reduced in height.

The automatic bread maker with the above-mentioned configuration may be realized by, for example, further including: a holding part for holding the grinding motor and the rotation shaft; a support shaft for supporting the holding part with respect to the lifting part so that the rotation shaft is allowed to be turned freely between the vertical direction and the horizontal direction; a protruding portion formed at a top of the holding part; and an attitude changer for changing an attitude of the holding part along with the lifting part moving up and down, in cooperation with the protruding portion.

With this configuration, when the lifting part is moved up, the holding part is turned and raised so that the rotation shaft is moved from a vertical position to a horizontal position, to thereby reduce time it takes to completely bring the holding part out of the bread container, which allows the following process to be started immediately thereafter. Further, the configuration also has an effect of turning the holding part without the use of a motor.

Further, in the automatic bread maker with the above-mentioned configuration, the retraction position is set to a position retracted to clear a space above the bread container. With this configuration, there may be easily obtained a structure for allowing the baked bread to be taken out from an upper surface of the automatic bread maker.

Further, the automatic bread maker with the above-mentioned configuration may be achieved by further including a lifting shaft extending in the vertical direction for guiding the lifting part which moves up and down, and having a structure in which the lifting part is turnable in a horizontal plane, with respect to the lifting shaft. With this configuration, after the lifting part holding the rotation shaft and the grinding motor is moved out of the bread container, the rotation shaft and the grinding motor are retracted to clear a space above the bread container. Then, when moving down the lifting part, the rotation shaft and the grinding motor may be returned from the retraction position to be placed above of the bread container.

It should be noted that, in the automatic bread maker with the above-mentioned configuration, a sheathing may be provided, which surrounds the rotation shaft and the grinding blade. With this configuration, the risk of injury to the fingers due to contact with the rotation shaft and the grinding blade may be reduced.

Further, in the automatic bread maker with the above-mentioned configuration, it is preferred that the bread container have a mixing/kneading blade disposed at the bottom thereof, and the baking chamber have a drive shaft disposed at a bottom thereof, the drive shaft being coupled to the mixing/kneading blade when the bread container is disposed at the bottom of the baking chamber. With this configuration, a series of breadmaking process from the process of grinding grains to the process of baking of bread may be performed seamlessly in the bread container placed inside the automatic bread maker.

The automatic bread maker with the above-mentioned configuration may further include a control device for controlling a lifting motor for moving the lifting part up and down, the grinding motor, and a mixing/kneading motor for rotating the drive shaft, and the control device may perform control so that a rotation of the grinding blade is stopped to provide a grinding downtime during a grinding process which is performed by rotating the grinding blade. With this configuration, the heat generated by the grinding is dissipated during the grinding downtime, with the result that the grinding operation may be performed without excessively increasing the temperature of the grains being ground.

Further, in the automatic bread maker with the above-mentioned configuration, the control device may perform control, during the grinding downtime, so that the lifting part is moved up, before rotating the mixing/kneading blade, to a position of allowing the mixing/kneading blade to rotate without one of coming into contact with the grinding blade and the rotation shaft or coming into contact with an outer body surrounding the grinding blade and the rotation shaft, and the mixing/kneading blade is rotated in this state. With this configuration, the grains are stirred by the mixing/kneading blade during the grinding, with the result that the grains are ground to be uniform in grain size.

Further, the automatic bread maker with the above-mentioned configuration may further include: a shielding lid for shielding an opening of the baking chamber; and a closing part for closing the baking chamber by moving the shielding lid, and the closing part may be controlled by the control device.

Further, in the automatic bread maker with the above-mentioned configuration, the motor for rotating the rotation shaft, and the motor for rotating the mixing/kneading blade inside the bread container or the mixing kneader may preferably be controlled by the control device in common. With this configuration, the rotation of the grinding blade and the rotation of the mixing/kneading blade (or the mixing kneader) may be controlled in association with each other, and hence the grinding blade and the mixing/kneading blade each may be applied with rotation suited for the type and amount of the grains in a stage of grinding the grains and in a stage of mixing/kneading the ground grains, to thereby improve the quality of the bread.

According to the present invention, bread may be baked by using grains (cereal grains) in hand, which eliminates the need to buy cereal flour. Further, a series of breadmaking process from the process of grinding the grains to the process of baking of bread may be performed seamlessly in the bread container placed inside the baking chamber, which reduces a risk that foreign matters are mixed into the bread dough. Further, unlike the case where grains are ground in another container and transferred into the bread container, there arises no loss, which may otherwise be produced as residual ground grains adhering to the another container due to the transfer of the grains.

In the case of rice, according to the present invention, rice flour bread may be made directly from rice grains with a desired rice milling rate. Accordingly, there may be made various kinds of bread such as, for example, brown rice bread made from brown rice which is rich in dietary fiber and maintains a high nutritional value, bread made from white rice or whole rice which is easy-to-digest, and bread made from partially-polished rice (such as 30% polished rice, 50% polished rice, 70% polished rice) with a rice milling rate which stands midway between white rice and brown rice. Such a difference in rice milling rate influences the nutritional value, and further makes a difference in texture which is influenced by the amount of fiber. Further, in addition to rice flour bread made from rice with varying rice milling rates, there may also be made rice flour bread from an improved variety of rice, namely, low-allergic rice which is low in protein as a main cause of rice allergy.

### BRIEF DESCRIPTION OF THE DRAWINGS

In the accompanying drawings:

FIG. 1 is a vertical sectional view of an automatic bread maker according to a first embodiment of the present invention;

FIG. 2 is another vertical sectional view of the automatic bread maker according to the first embodiment of the present invention, which is taken along the section orthogonal to FIG. 1;

FIG. 3 is a top view of the automatic bread maker according to the first embodiment of the present invention;

FIG. 4 is a front view of a grinding unit of the automatic bread maker according to the first embodiment of the present invention;

FIG. 5 is a vertical sectional view of the grinding unit of the automatic bread maker according to the first embodiment of the present invention;

FIG. 6 is a bottom view of a grinding blade and a sheathing, which form the grinding unit of the automatic bread maker according to the first embodiment of the present invention;

FIG. 7 is a vertical sectional view of the automatic bread maker according to the first embodiment of the present invention, illustrating a state in which the grinding unit is pulled out from a lid;

FIG. 8 is another vertical sectional view of the automatic bread maker according to the first embodiment of the present invention, illustrating the state in which the grinding unit is pulled out from the lid, which is taken along the section orthogonal to FIG. 7;

FIG. 9 is a control block diagram of the automatic bread maker according to the first embodiment of the present invention;

FIG. 10 is an overall flow chart illustrating a breadmaking process according to a first aspect of the present invention;

FIG. 11 is a flow chart illustrating a pre-grinding impregnation process in the breadmaking process according to the first aspect;

FIG. 12 is a flow chart illustrating a grinding process in the breadmaking process according to the first aspect;

FIG. 13 is a flowchart illustrating a mixing/kneading process in the breadmaking process according to the first aspect;

FIG. 14 is a flow chart illustrating a fermentation process in the breadmaking process according to the first aspect;

FIG. 15 is a flow chart illustrating a baking process in the breadmaking process according to the first aspect;

FIG. 16 is an overall flow chart illustrating a breadmaking process according to a second aspect of the present invention;

FIG. 17 is a flow chart illustrating a post-grinding impregnation process in the breadmaking process according to the second aspect;

FIG. 18 is an overall flow chart illustrating a breadmaking process according to a third aspect of the present invention;

FIG. 19 is a vertical sectional view of an automatic bread maker according to a modified example of the first embodiment of the present invention;

FIG. 20 is another vertical sectional view of the automatic bread maker according to the modified example of the first embodiment of the present invention, which is taken along the section orthogonal to FIG. 19;

FIG. 21 is a front view of a grinding unit assembly of the automatic bread maker according to the modified example of the first embodiment of the present invention;

FIG. 22 is a vertical sectional view of the grinding unit assembly of the automatic bread maker according to the modified example of the first embodiment of the present invention;

FIG. 23 is a vertical sectional view of the automatic bread maker according to the modified example of the first embodiment of the present invention, illustrating a state in which a lid is lifted up;

FIG. 24 is another vertical sectional view of the automatic bread maker according to the modified example of the first embodiment of the present invention, illustrating a state in which the lid is placed in an open position after being lifted up;

FIG. 25 is a vertical sectional view of an automatic bread maker according to a second embodiment of the present invention;

FIG. 26 is another vertical sectional view of the automatic bread maker similar to that of FIG. 25, which illustrates a state different from that of FIG. 25;

FIG. 27 is a side view of a rotation shaft, which illustrates a mixing kneader in cross section;

FIG. 28 is a top view of the mixing kneader;

FIG. 29 is a bottom view of the mixing kneader and a grinding blade;

FIG. 30 is a first explanatory diagram for illustrating a mixing/kneading operation;

FIG. 31 is a second explanatory diagram for illustrating the mixing/kneading operation;

FIG. 32 is a third explanatory diagram for illustrating the mixing/kneading operation;

FIG. 33 is a fourth explanatory diagram for illustrating the mixing/kneading operation;

FIG. 34 is a fifth explanatory diagram for illustrating the mixing/kneading operation;

FIG. 35 is a control block diagram of the automatic bread maker according to the second embodiment of the present invention;

FIG. 36 is a front view of an automatic bread maker according to a third embodiment of the present invention;

FIG. 37 is a vertical sectional view of the automatic bread maker of FIG. 36;

FIG. 38 is another vertical sectional view of the automatic bread maker of FIG. 36, which is taken along the section orthogonal to FIG. 37;

FIG. 39 is a still further vertical sectional view of the automatic bread maker similar to that of FIG. 37, which illustrates a state different from that of FIG. 37;

FIG. 40 is a yet further vertical sectional view of the automatic bread maker in the state illustrated in FIG. 39, which is taken along the section orthogonal to FIG. 39;

FIG. 41 is a control block diagram of the automatic bread maker according to the third embodiment of the present invention;

FIG. 42 is a vertical sectional view of an automatic bread maker according to a fourth embodiment of the present invention;

FIG. 43 is a horizontal sectional view of the automatic bread maker of FIG. 42;

FIG. 44 is another vertical sectional view of the automatic bread maker similar to that of FIG. 42, in which an elevator is on the way of making a descent;

FIG. 45 is a still further vertical sectional view of the automatic bread maker similar to that of FIG. 42, in which the descent of the elevator is completed;

FIG. 46 is a horizontal sectional view of the automatic bread maker of FIG. 45;

FIG. 47 is a control block diagram of the automatic bread maker according to the fourth embodiment of the present invention;

FIG. 48 is a vertical sectional view of an automatic bread maker according to a modified example of the fourth embodiment of the present invention;

FIG. 49 is a horizontal sectional view of the automatic bread maker of FIG. 48;

FIG. 50 is another vertical sectional view of the automatic bread maker similar to that of FIG. 48, in which the elevator is put into a descendible state;

FIG. 51 is a horizontal sectional view of the automatic bread maker of FIG. 50;

FIG. 52 is a still further vertical sectional view of the automatic bread maker similar to that of FIG. 48, in which the descent of the elevator is completed;

FIG. 53 is a yet further vertical sectional view of the automatic bread maker similar to that of FIG. 48, in which the elevator is moved up to an intermediate position;

FIG. 54 is a yet further vertical sectional view of the automatic bread maker illustrating a state in which a mixing/kneading blade is rotated in the state illustrated in FIG. 53; and

FIG. 55 is an operation chart of constituent elements in a grinding process.

### DETAILED DESCRIPTION OF THE PREFERRED EMBODIMENTS

In the following, embodiments of the automatic bread maker according to the present invention are described with reference to the accompanying drawings.

### First Embodiment

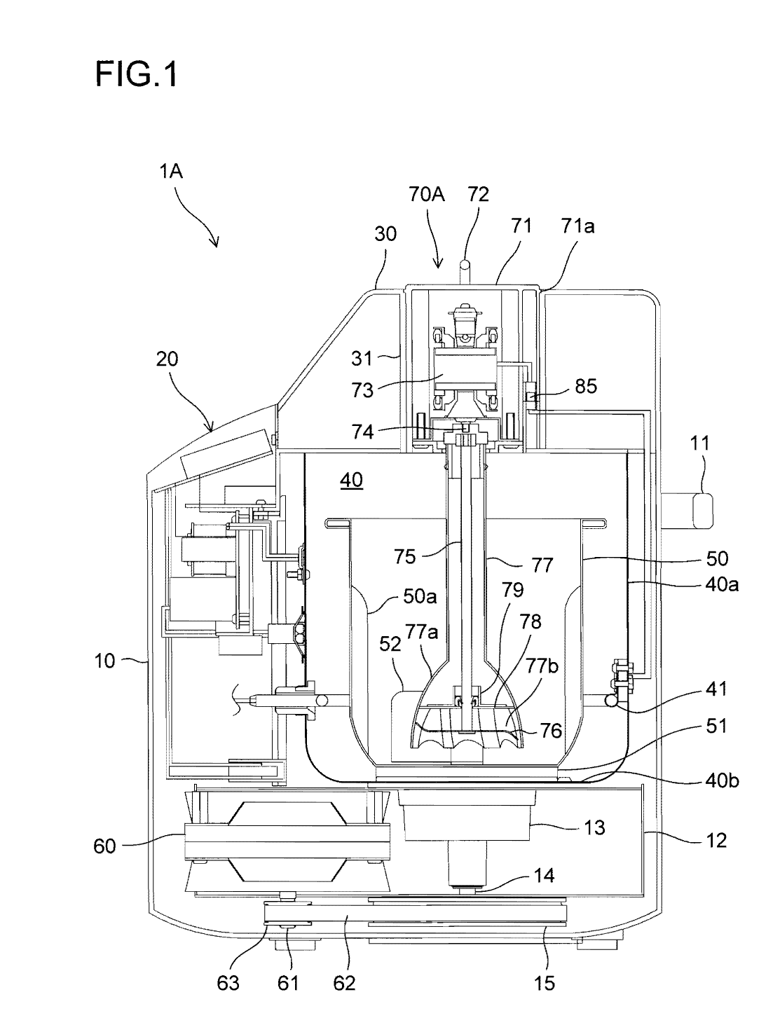

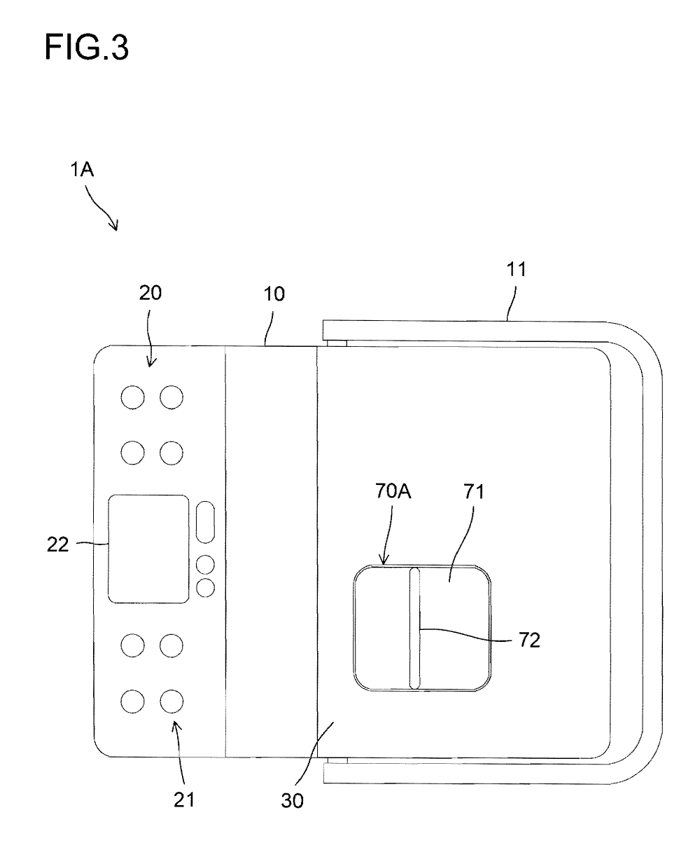

An automatic bread maker 1A according to a first embodiment of the present invention is described with reference to FIGS. 1 to 18. In FIGS. 1 and 3, a front surface side of the automatic bread maker 1A is on the left side of FIGS. 1 and 3, while a back surface (rear surface) side of the automatic bread maker 1A is on the right side of FIGS. 1 and 3. Further, the left side of the automatic bread maker 1A falls on the left-hand side of an observer facing the automatic bread maker 1A in front thereof, and the right side of the automatic bread maker 1A falls on the right-hand side of the observer.

The automatic bread maker 1A includes a body 10 in a box shape. The body 10 is provided with an outer shell made of a synthetic resin. A synthetic resin handle 11 in a U-shape is attached at both ends to the left side surface and the right side surface of the body 10, and the synthetic resin handle 11 may be held for hand-carrying the body 10.

A console part 20 is formed on an upper surface side of the body 10 (see, for example, FIG. 3). The console part 20 is provided with an operation key group 21 and a display part 22. The operation key group 21 includes a selection key for selecting a kind of bread (such as wheat bread, rice flour bread, and bread with filling), a recipe selection key, a timer key, a start key, and a cancel key. The display part 22 displays the specified recipe, a time set by a timer, and the like. The display part 22 is formed of a liquid crystal display panel.

The rest of the upper surface of the body 10 situated behind the console part 20 is covered by a lid 30 made of a synthetic resin (see, for example, FIG. 1). The lid 30 is attached to an edge on the back surface side of the body 10 via a hinge shaft (not shown), and turns in vertical plane using the hinge shaft as a support point.

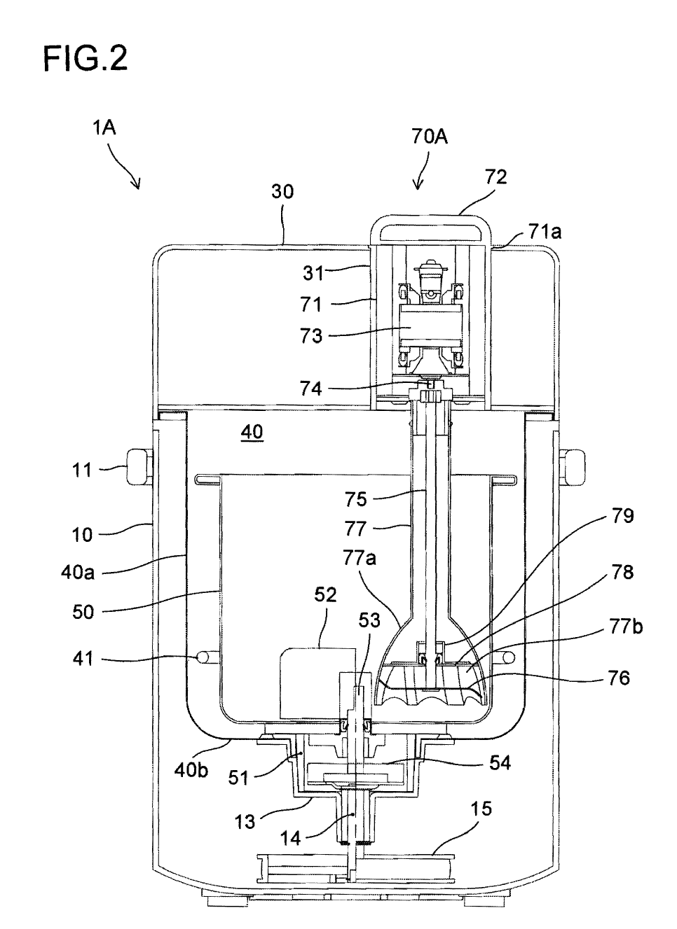

A baking chamber 40 is provided inside the body 10 (see, for example, FIGS. 1 and 2). The baking chamber 40 is made of a sheet metal, and opens at an upper side thereof, from which a bread container 50 is inserted therein. The baking chamber 40 has a peripheral side wall 40a which is rectangular in horizontal section and a bottom wall 40b.

The bottom wall 40b of the baking chamber 40 has a bread container support 13 fixed thereto, at a position in the center of the baking chamber 40 (see, for example, FIGS. 1 and 2). The bread container support 13 is a die-cast component of an aluminum alloy. The bread container support 13 has its inside exposed to the inside of the baking chamber 40 via an opening formed in the bottom wall 40b of the baking chamber 40.

The bread container support 13 supports, at the center thereof, a vertical rotation shaft (drive shaft) 14 (see, for example, FIG. 2). The rotation shaft 14 protrudes, at a lower end thereof, from a lower surface of the bread container support 13, and a pulley 15 is fixed to the lower end of the rotation shaft 14.

The bread container support 13 receives a cylindrical pedestal 51 fixed to a bottom surface of the bread container 50, to thereby support the bread container 50. The pedestal 51 is also a die-cast component of an aluminum alloy.

The bread container 50 is made of a sheet metal, and formed in a bucket-like shape (see, for example, FIGS. 1 and 2). The bread container 50 is provided with a carrying handle (not shown) attached to a rim of an opening on an upper side thereof. The bread container 50 is rectangular with rounded corners in horizontal section, and has a convex portion 50a, which is in a ridge shape extending in a vertical direction, formed on an inner surface of each of two opposing sides of the four sides.

The bread container 50 has a mixing/kneading blade 52 disposed at the center of the bottom. The mixing/kneading blade 52 is attached by being simply engaged with a noncircular section at an upper end of a vertical rotation shaft (blade rotation shaft) 53 which is supported at the center of the bottom of the bread container 50 and is sealed against leakage, and hence the mixing/kneading blade 52 is detachable without the use of tools. Accordingly, the mixing/kneading blade 52 is easily replaceable with another type thereof.

The rotation shaft 53 is coupled to the rotation shaft 14, and receives power transmitted from the rotation shaft 14. For the transmission of power, a coupling 54 accommodated in the pedestal 51 is used (see FIG. 2). Specifically, the coupling 54 is formed of two members, and one of the members is fixed to a lower end of the rotation shaft 53 while the other one is fixed to an upper end of the rotation shaft 14.

Protrusions (not shown) are each formed on an inner peripheral surface of the bread container support 13 and on an outer peripheral surface of the pedestal 51. The protrusions form a known bayonet coupling. Specifically, when mounting the bread container 50 onto the bread container support 13, the bread container 50 is held down in a manner that the protrusion from the pedestal 51 does not interfere with the protrusion from the bread container support 13. Once the pedestal 51 is fit into the bread container support 13, the bread container 50 is twisted horizontally, so that the protrusion from the pedestal 51 engages with a lower surface of the protrusion from the bread container support 13, to thereby prevent the bread container 50 from being pulled out upward. This operation also attains coupling of the coupling 54. The bread container 50 to be mounted is twisted in a rotation direction of the mixing/kneading blade 52, so that the bread container 50 may not be detached even when the mixing/kneading blade 52 is rotated.

A heating device 41 disposed inside the baking chamber 40 (see, for example, FIGS. 1 and 2) surrounds the bread container 50, to thereby heat breadmaking materials. The heating device 41 is formed of a sheathed heater.

The body 10 has a base 12 disposed therein. The base 12 is made of a sheet metal. A motor (mixing/kneading motor) 60 is attached to the base 12. The motor 60 has a vertical shaft, and has an output shaft 61 protruding from a lower surface thereof. A pulley 63 is fixed to the output shaft 61, and the pulley 63 is coupled to the pulley 15 of the rotation shaft 14 via a belt 62.

In the lid 30, a vertical penetrating part 31 formed in a cylindrical shape is formed (see, for example, FIGS. 1 and 2). The vertical penetrating part 31 is formed at a position displaced slightly to the right from the center of the bread container 50. Then, a grinding unit 70A is inserted from above into the vertical penetrating part 31.

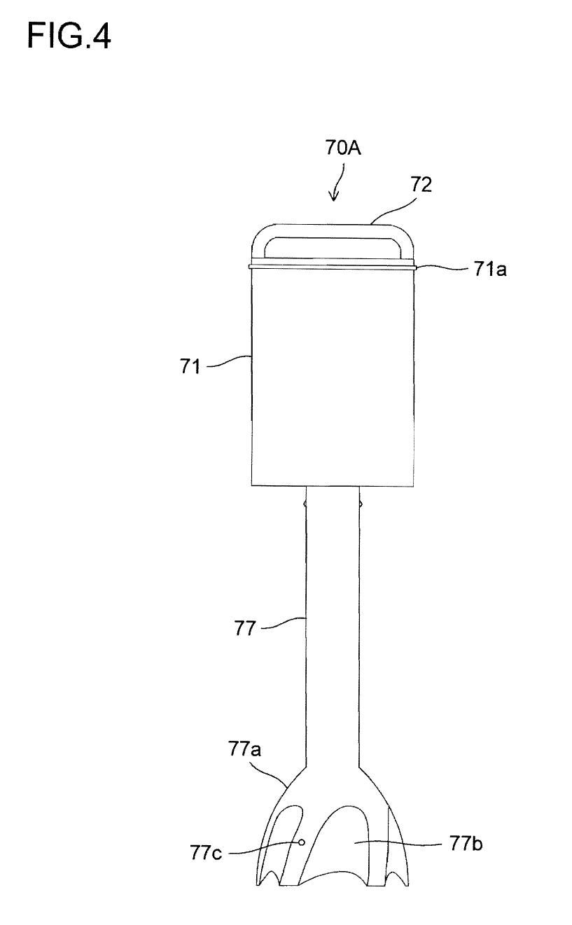

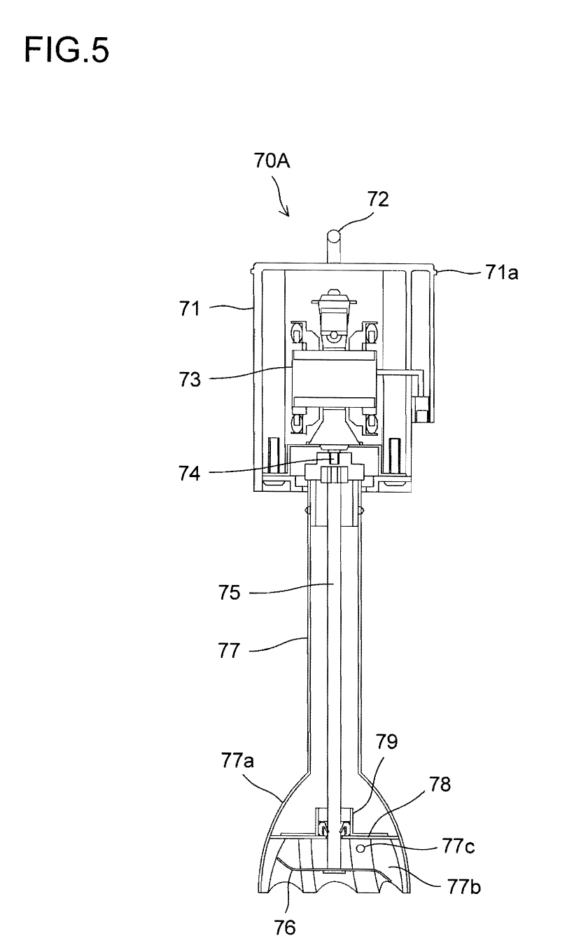

The grinding unit 70A includes a motor case 71 (see, for example, FIGS. 4 and 5) made of a synthetic resin. The motor case 71 has a handle 72 formed on an upper surface thereof, and incorporates a motor (grinding motor) 73 with a vertical shaft. The motor case 71 has an annular ledge 71a formed around an upper periphery thereof. The ledge 71a engages with an upper edge of the vertical penetrating part 31, to thereby hinder the motor case 71 from being pressed further downward. When the motor case 71 is stopped going downward by the ledge 71a, the upper surface of the motor case 71 becomes substantially flush with an upper surface of the lid 30. The vertical penetrating part 31 and the motor case 71 are both quadrangular in horizontal section, and the grinding unit 70A inserted into the lid 30 do not rotate with respect to the lid 30.

A rotation shaft 75 is coupled to an output shaft 74 protruding downward from the motor 73. A grinding blade 76 is fixed to a lower end of the rotation shaft 75. A sheathing 77, which is fixed at an upper end thereof to the motor case 71, surrounds the rotation shaft 75 and the grinding blade 76. The sheathing 77 is a cylindrical member made of a sheet metal such as a stainless steel plate. A lower end of the sheathing 77, that is, a portion surrounding the grinding blade 76, is formed into a bulged portion 77a which is larger in diameter than the rest portion and shaped like a tulip flower turned upside down.

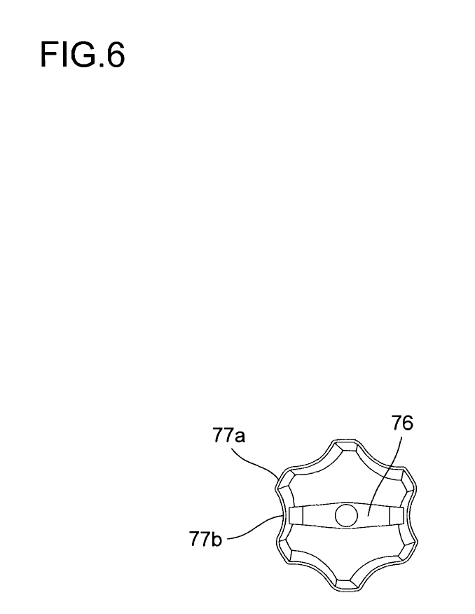

An inner surface of the bulged portion 77a has convexities 77b opposing to the grinding blade 76. According to the first embodiment, the bulged portion 77a is dented inwardly at predetermined angular intervals, to thereby form the convexities 77b (see FIG. 6). A horizontal beam 78 is fixed inside the bulged portion 77a, and a bearing 79 for bearing the rotation shaft 75 is attached to the beam 78. Further, the bulged portion 77a has an air vent hole 77c formed above a level of the grinding blade 76 (see FIGS. 4 and 5).

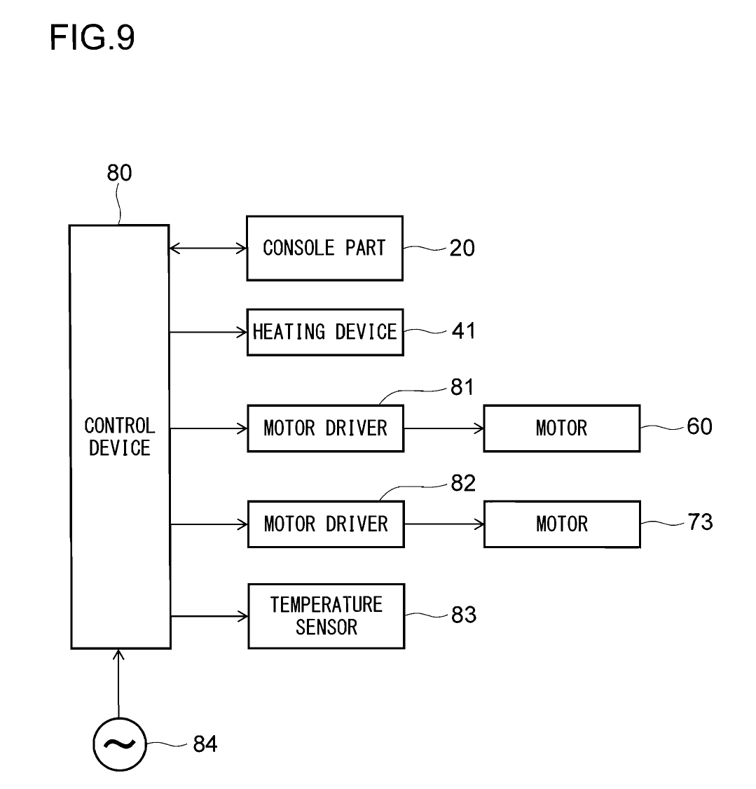

An operation of the automatic bread maker 1A is controlled by a control device 80 illustrated in FIG. 9. The control device 80 is formed of a circuit board disposed in an appropriate place inside the body 10 (place unsusceptible to heat of the baking chamber 40 is preferable). The control device 80 is connected to the console part 20 and the heating device 41, which have been described above, and is further connected to a motor driver 81 for the motor (mixing/kneading motor) 60, to a motor driver 82 for the motor (grinding motor) 73, and to a temperature sensor 83. The temperature sensor 83 is disposed inside the baking chamber 40, and detects temperature of the baking chamber 40. A commercial power source 84 supplies power to each constituent element.

The motor 73 and the motor driver 82 are connected to each other via a connector 85, which is configured to establish connection inside the vertical penetrating part 31 (see FIG. 1). One end of the connector 85 is fixed to an inner surface of the vertical penetrating part 31, and another end thereof is fixed to the motor case 71. When the motor case 71 is inserted into the vertical penetrating part 31, the connector 85 establishes connection.

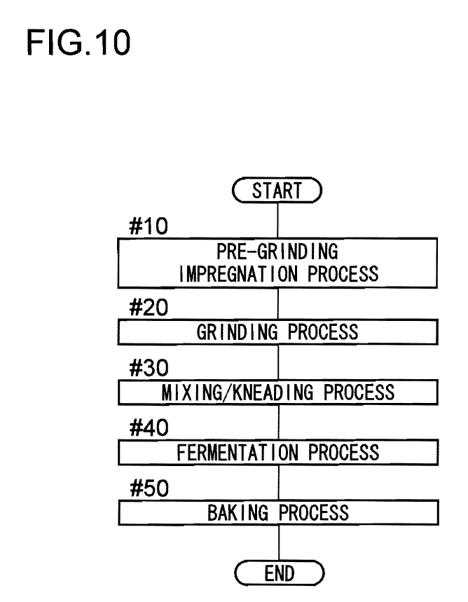

Next, a process of making bread from grains by using the automatic bread maker 1A is described with reference to FIGS. 10 to 18. Of the drawings, FIGS. 10 to 15 illustrate a breadmaking process according to a first aspect of the present invention.

FIG. 10 is an overall flow chart illustrating a breadmaking process according to the first aspect of the present invention. As illustrated in FIG. 10, according to the first aspect, the process includes a pre-grinding impregnation process #10, a grinding process #20, a mixing/kneading process #30, a fermentation process #40, and a baking process #50, which are sequentially performed in the stated order. Next, each of the processes is described in detail.

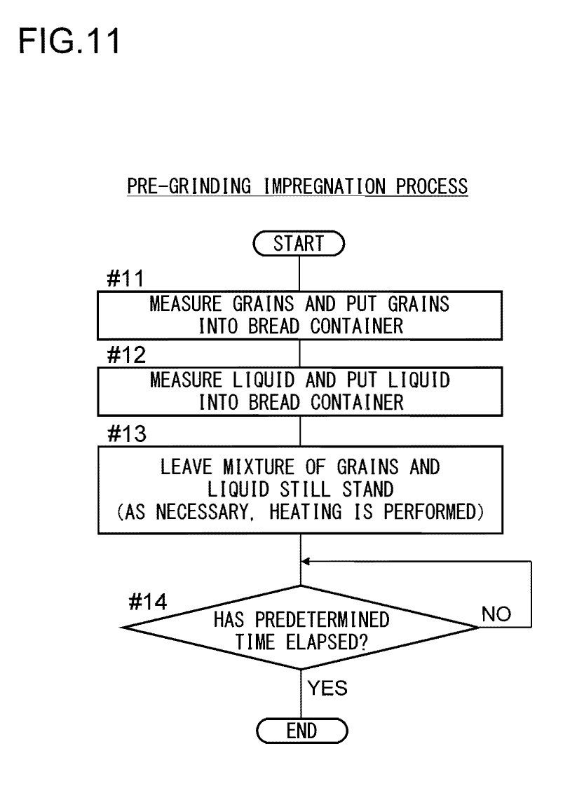

In the pre-grinding impregnation process #10 illustrated in FIG. 11, first in Step #11, a user measures a predetermined amount of grains, and puts the grains into the bread container 50. Rice grains may be most easily available as the grains. Alternatively, grains of other kinds of cereals, such as wheat, barley, foxtail millet, Japanese barnyard millet, buck wheat, and corn may also be used.

In Step #12, the user measures a predetermined amount of liquid, and puts the liquid into the bread container 50. Water may be most commonly used as the liquid. Alternatively, there may also be used liquid with a flavor, such as soup stock or fruit juice. The liquid may contain alcohol. It should be noted that Step #11 and Step #12 may be interchanged with each other in sequence.

The grains and the liquid may be put into the bread container 50 which is taken out from the baking chamber 40, or may be put into the bread container 50 which is placed inside the baking chamber 40. When opening the lid 30 to put in and take out the bread container 50 or to put grains and liquid into the bread container 50 inside of the baking chamber 40, the grinding unit 70A is pulled out from the lid 30 in advance.

When the grains and the liquid are put into the bread container 50 inside of the baking chamber 40, or when the bread container 50 containing the grains and the liquid put thereinto outside the baking chamber 40 is installed into the baking chamber 40, the lid 30 is closed and the grinding unit 70A is inserted into the vertical penetrating part 31. When the grinding unit 70A is inserted downward to be stopped by the ledge 71a, the connector 85 establishes connection while the rotation shaft 75 provided with the grinding blade 76 at a lower end thereof and the sheathing 77 surrounding the same are disposed inside the bread container 50 as hanging down from a lower surface of the lid 30.

The mixing/kneading blade 52 is turned in advance to a direction of avoiding contact with the sheathing 77 descending from above. Alternatively, an origin position of the mixing/kneading blade 52 may be set to a position of avoiding contact with the sheathing 77, and the mixing/kneading blade 52 may be configured to always stop at the origin position after rotation.

In a state in which the grinding unit 70A is completely inserted into the vertical penetrating part 31, the grinding blade 76 and a lower end of the bulged portion 77a of the sheathing 77 are brought close to an inner bottom surface of the bread container 50 at a predetermined distance. In this state, the user presses a predetermined operation key in the console part 20 to start counting time for liquid impregnation. From this time point on, Step #13 is started.

In Step #13, a mixture of the grains and the liquid is left still stand in the bread container 50, to thereby impregnate the grains with the liquid. In general, the impregnation is further promoted as the liquid temperature becomes higher. In view of this, the heating device 41 may be energized so that the temperature of the baking chamber 40 may be increased.

In Step #14, the control device 80 checks how much time has elapsed since the start of the still standing of the grains and the liquid. After a lapse of a predetermined time, the pre-grinding impregnation process #10 is ended, which is informed to the user by display in the display part 22 or by voice.

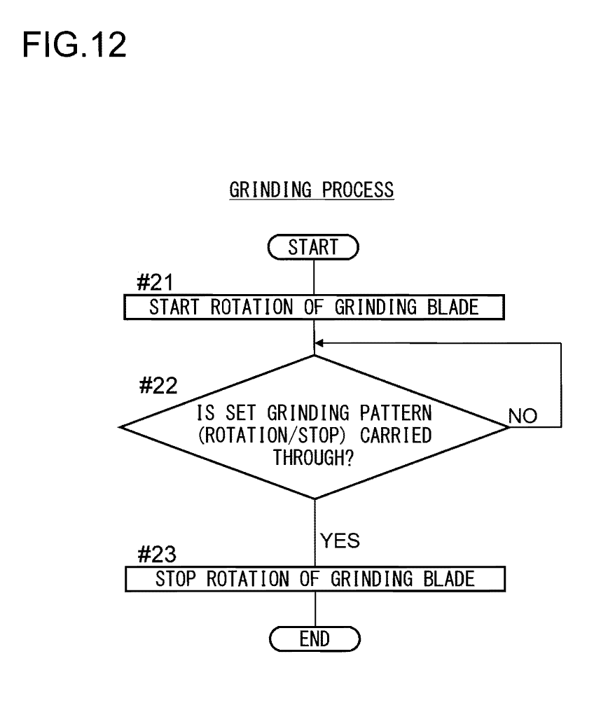

Following the pre-grinding impregnation process #10, the grinding process #20 illustrated in FIG. 12 is performed. The user inputs data on the grinding operation (such as a kind and an amount of the grains and a kind of bread to be baked) via the console part 20, and presses the start key, to thereby start grinding.

In Step #21, the control device 80 drives the motor 73 of the grinding unit 70A, to thereby rotate the rotation shaft 75. In this manner, the grinding blade 76 starts rotation in the mixture of the grains and the liquid. The grains to be ground by the grinding blade 76 are impregnated beforehand with the liquid, and therefore the grains may be easily ground to the core. The convexities 77b formed in the inner surface of the bulged portion 77a of the sheathing 77 suppress the flow of the mixture of the grains and the liquid, to thereby promote the grinding. The bulged portion 77a has the air vent hole 77c formed therein, and hence air does not build up inside the bulged portion 77a. Accordingly, the entry of the mixture of the grains and the liquid into the bulged portion 77a is not inhibited by air, with the result that the grinding may be performed reliably.

In the manner as described above, during the rotation of the grinding blade 76, the grains in the bread container 50 go into the bulged portion 77a together with the liquid through a gap between the bulged portion 77a and the inner bottom surface of the bread container 50 to be ground by the grinding blade 76, and go out of the bulged portion 77a, in a repetitive manner, so that the grains are ground down into small pieces.

In Step #22, the control device 80 checks whether the grinding pattern is carried through according to the settings (such as, as to whether the grinding blade is continuously rotated or intermittently rotated at intervals, and in a case of rotating the grinding blade intermittently, as to how the intervals are provided and how the duration of the rotation is set) for obtaining desired ground grains. When the grinding pattern according to the settings is carried through, the process proceeds to Step #23, in which the rotation of the grinding blade 76 is stopped, and the grinding process #20 is ended. The end of the grinding process #20 is informed to the user by display in the display part 22 or by voice.

It has been described in the above that the grinding process #20 is started in response to an operation by the user after the pre-grinding impregnation process #10. However, the present invention is not limited thereto. Alternatively, the user may input data on the grinding operation before the pre-grinding impregnation process #10 or during the pre-grinding impregnation process #10, so that the grinding process #20 may be automatically started after the completion of the pre-grinding impregnation process #10.

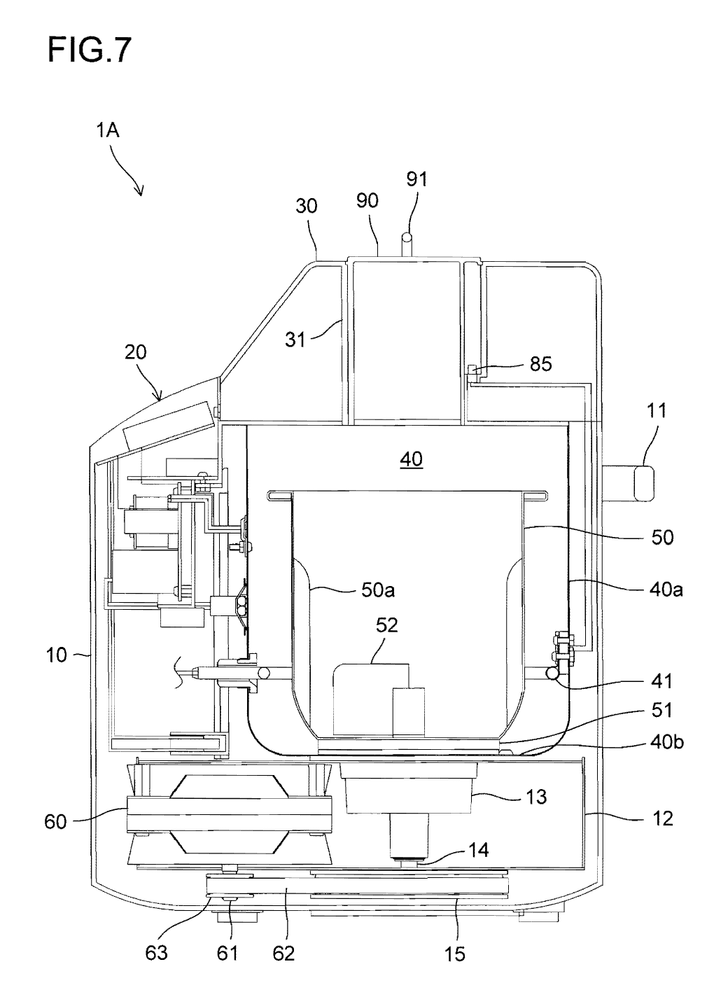

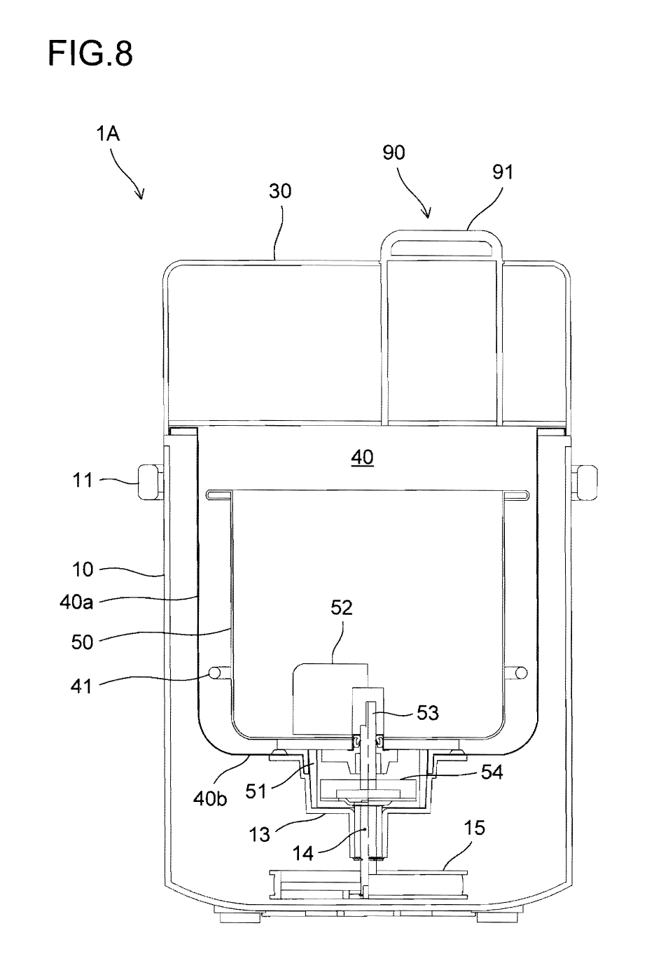

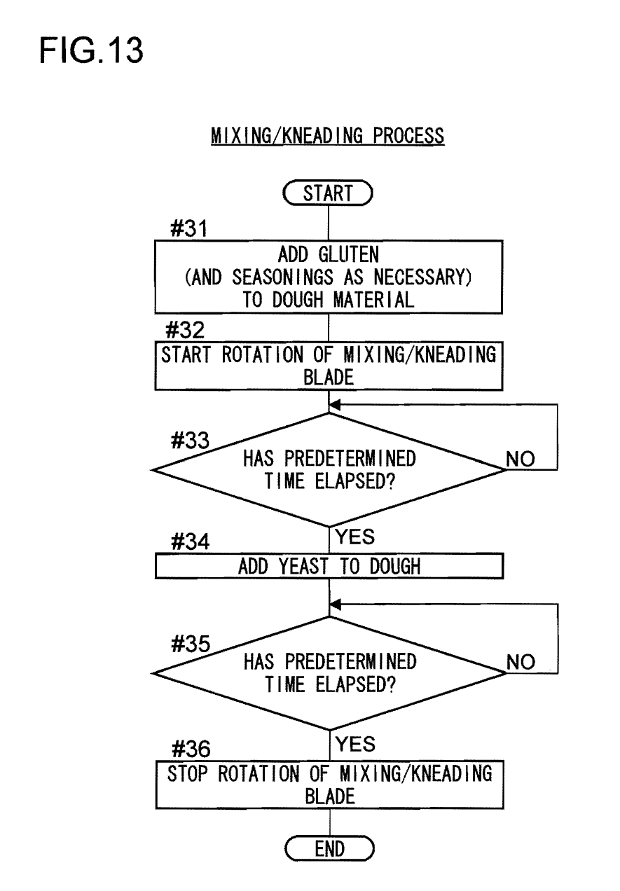

Following the grinding process #20, the mixing/kneading process #30 illustrated in FIG. 13 is performed. Prior to the mixing/kneading process #30, the user pulls out the grinding unit 70A from the lid 30, and inserts a dummy stopper 90 in place of the grinding unit 70A into the vertical penetrating part 31 as illustrated in FIGS. 7 and 8. The dummy stopper 90 is the same in dimension as the motor case 71, and has a handle 91 provided on an upper surface thereof.

It should be noted that, if the mixing/kneading blade 52 is rotated in a state in which the sheathing 77 is hanging down inside the bread container 50, the mixing/kneading blade 52 inevitably collides with the sheathing 77. In view of this, a detector for detecting the presence of the sheathing 77 in the bread container 50 may be provided, and the motor 60 may be prevented from being driven as long as the detector is detecting the presence of the sheathing 77.

When starting the mixing/kneading process #30, the grains and the liquid in the bread container 50 are in the form of a dough material in paste form or in slurry form. It should be noted that, in this specification, the materials which are found at a time point of starting the mixing/kneading process #30 are collectively referred to as “dough material”, while the materials which are further mixed and kneaded to be almost turned into a desired dough state are collectively referred to as “dough” even in an unfinished state.

In Step #31, the user adds a predetermined amount of gluten to the dough material. As necessary, seasonings, such as salt, sugar, and shortening may also be added. It should be noted that the seasonings may be put in advance into the bread container 50 at an initiation stage of the grinding process #10. Alternatively, the automatic bread maker 1A may be provided with an automatic dispenser device for dispensing gluten and seasonings, so that those materials may be added without having the user take the trouble to do so.

Before or after Step #31, the user makes an input via the console part 20 to select a kind of bread and a recipe. When the settings are ready, the user presses the start key to start a breadmaking operation which is performed in an automatic sequence of the mixing/kneading process #30, the fermentation process #40, and the baking process #50.

In Step #32, the control device 80 drives the motor 60. As a result, the mixing/kneading blade 52 starts rotation in the dough material. Further, the control device 80 energizes the heating device 40 as necessary, to thereby increase the temperature of the baking chamber 40. Along with the rotation of the mixing/kneading blade 52, the dough material is further mixed and kneaded into dough which comes together and exhibits a predetermined degree of elasticity. The mixing/kneading blade 52 brings the dough up and down to beat the dough on an inner wall of the bread container 50, which adds an element of “kneading” to the mixing. The convex portions 50a formed on the inner walls of the bread container 50 help the “kneading”.

In Step #33, the control device 80 checks how much time has elapsed since the start of the rotation of the mixing/kneading blade 52. After a lapse of a predetermined time, the process proceeds to Step #34. In Step #34, the user opens the lid 30 and adds yeast to the dough.

In Step #35, the control device 80 checks how much time has elapsed since the dough is added with yeast. After a lapse of time necessary for obtaining a desired dough, the process proceeds to Step #36, where the rotation of the mixing/kneading blade 52 is stopped. At this point, the dough material is completed into dough which comes together and exhibits a necessary degree of elasticity.

It should be noted that dry yeast may be used as the yeast to be added to the dough in Step #34. Alternatively, a baking powder may be used in place of the yeast. Further, an automatic dispenser device may also be adopted for dispensing the yeast or the baking powder, to thereby save the user the trouble. When making bread with fillings, the fillings are added in any one of the steps in the mixing/kneading process #30. An automatic dispenser device may also be adopted for adding the fillings.

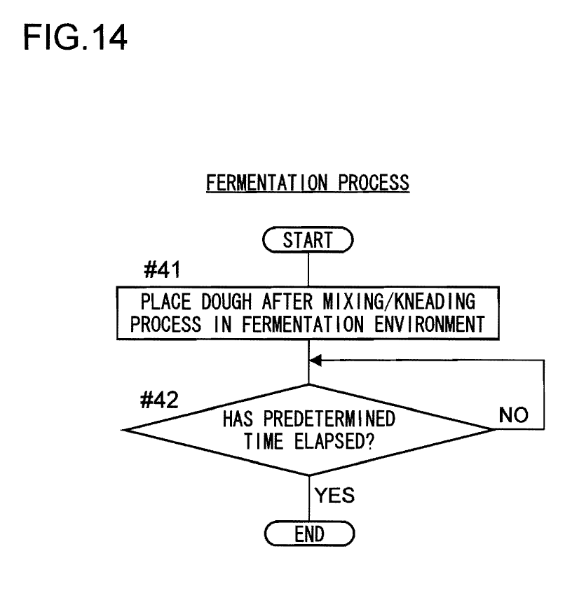

Following the mixing/kneading process #30, the fermentation process #40 illustrated in FIG. 14 is performed. In Step #41, the dough, which has undergone the mixing/kneading process #30, is placed in a fermentation environment. Specifically, the control device 80 energizes the heating device 41 as necessary to maintain the baking chamber 40 in a temperature zone in which fermentation is promoted. The user shapes the dough as necessary and leaves the dough still stand in the baking chamber 40.

In Step #42, the control device 80 checks how long the dough has been placed in the fermentation environment. After a lapse of a predetermined time, the fermentation process #40 is ended.

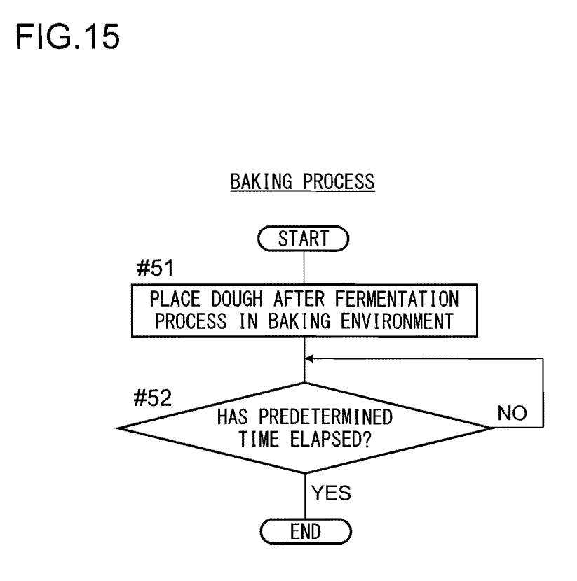

Following the fermentation process #40, the baking process #50 illustrated in FIG. 15 is performed. In Step #51, the dough thus fermented is placed in a baking environment. Specifically, the control device 80 supplies power necessary for baking bread to the heating device 41, so that the temperature of the baking chamber 40 is increased to a temperature zone for baking bread.

In Step #52, the control device 80 checks how long the dough has been placed in the baking environment. After a lapse of a predetermined time, the baking process #50 is ended. At this time, the completion of breadmaking is informed by display in the display part 22 or by voice, and the user opens the lid 30 to take out the bread container 50.

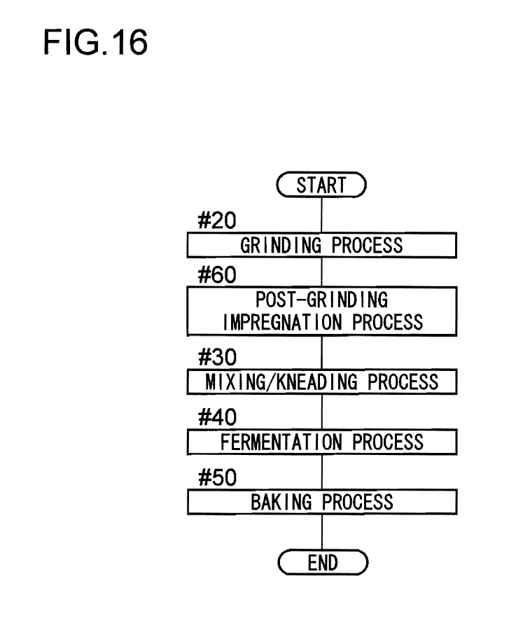

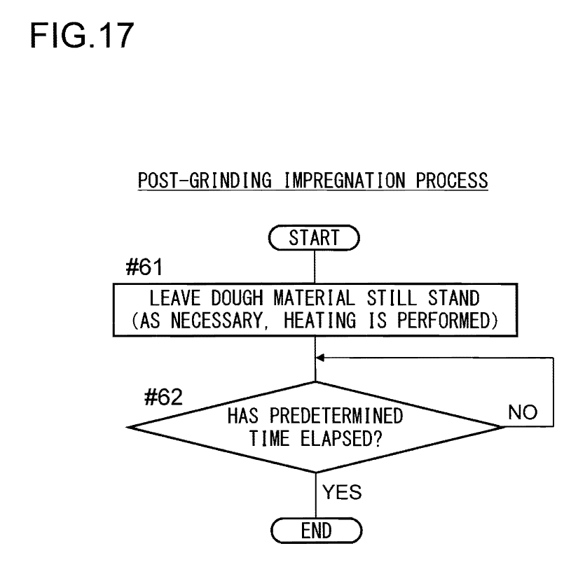

Next, a breadmaking process according to a second aspect of the present invention is described with reference to FIGS. 16 and 17. FIG. 16 is an overall flow chart illustrating the breadmaking process according to the second aspect. In FIG. 16, the process includes the grinding process #20, a post-grinding impregnation process #60, the mixing/kneading process #30, the fermentation process #40, and the baking process #50, which are performed in the stated order. Next, the post-grinding impregnation process #60 is described in detail with reference to FIG. 17.

In Step #61, the dough material formed in the grinding process #20 (which is performed similarly to that according to the first aspect) is left still stand in the bread container 50. The dough material is formed without being subjected to the pre-grinding impregnation process. The ground grains are impregnated with the liquid during the still standing. The control device 80 energizes the heating device 41 as necessary to heat the dough material, so that the impregnation is promoted.

In Step #62, the control device 80 checks how long the dough material has been left still stand. After a lapse of a predetermined time, the post-grinding impregnation process #60 is ended. After the completion of the post-grinding impregnation process #60, the process automatically proceeds to the mixing/kneading process #30. The mixing/kneading process #30 and the processes thereafter are similar to those of the breadmaking process according to the first aspect.

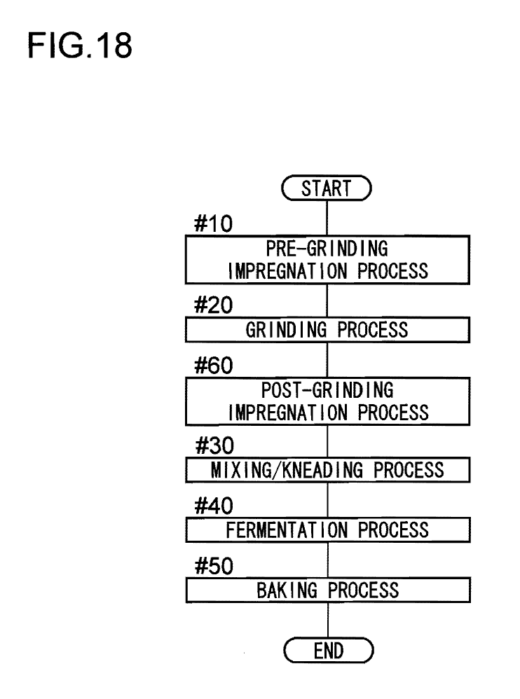

Next, a breadmaking process according to a third aspect of the present invention is described with reference to FIG. 18. FIG. 18 is an overall flow chart illustrating the breadmaking process according to the third aspect. In the breadmaking process according to the third aspect, the pre-grinding impregnation process #10 according to the first aspect precedes the grinding process #20, and the post-grinding impregnation process #60 according to the second aspect follows the grinding process #20. The mixing/kneading process #30 and the processes thereafter are similar to those of the breadmaking process according to the first aspect.

The grinding unit 70A may also be used for pulverizing fillings such as nuts and leaf vegetables into small particles, as well as for grinding grains. Accordingly, bread with finely-ground fillings may be baked. The grinding unit 70A may also be used for pulverizing foodstuffs and herbal medicines, other than the fillings to be mixed into bread.

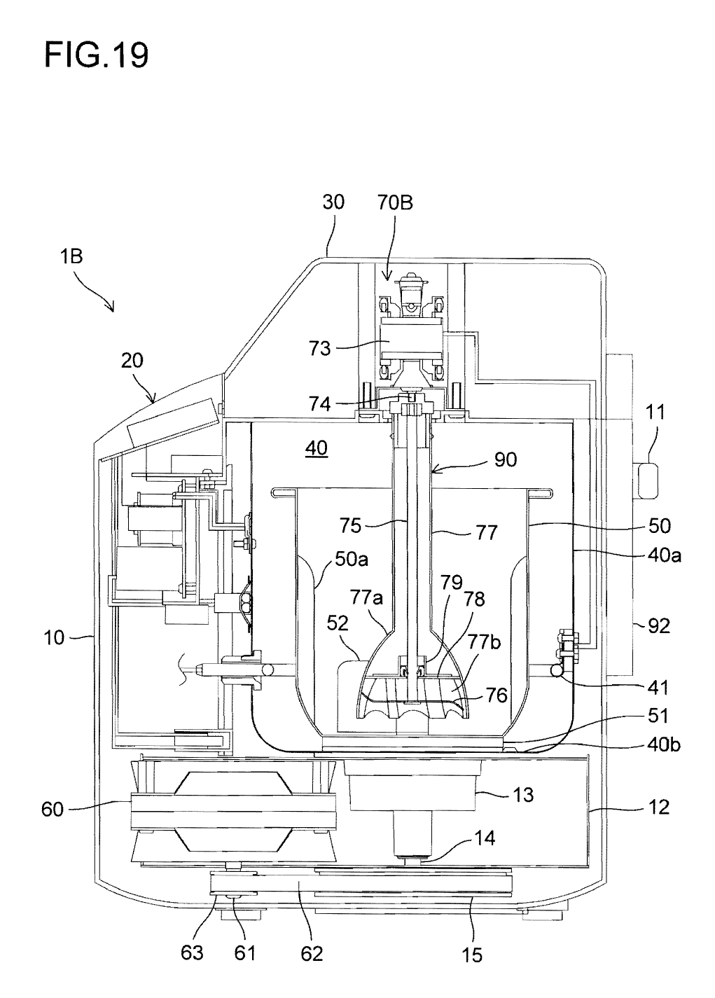

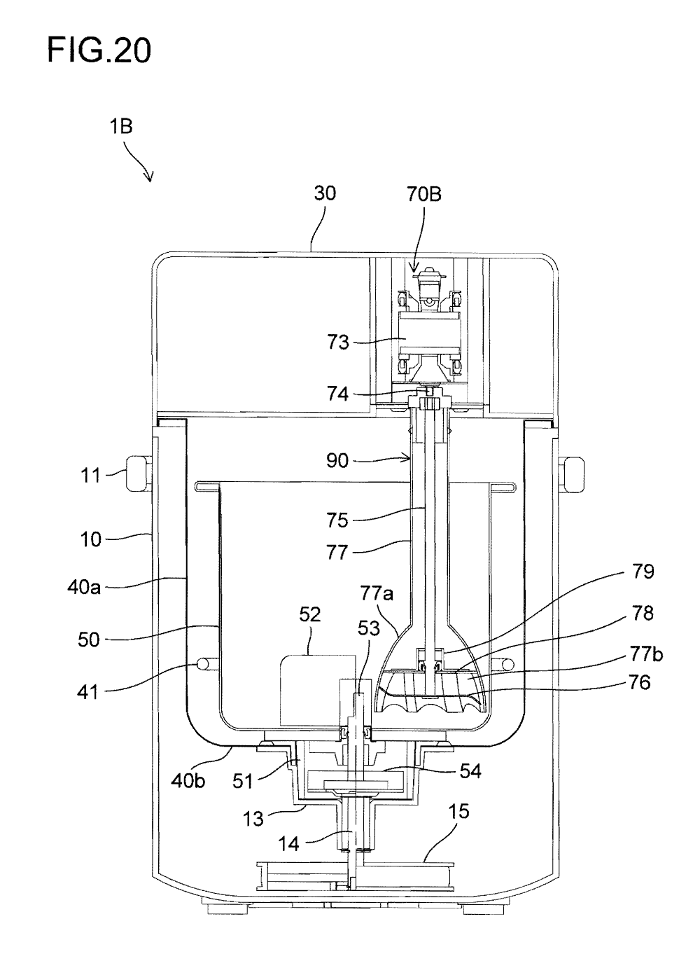

Next, with reference to FIGS. 19 to 24, a modified example of the first embodiment of the present invention is described. It should be noted that, in the modified example of the first embodiment, constituent elements which are the same as or share a function in common with those of the first embodiment are denoted by the same reference symbols used in the first embodiment, and the description thereof is omitted.

An automatic bread maker 1B according to the modified example of the first embodiment is different from the automatic bread maker 1A according to the first embodiment in terms of configuration of the grinding unit. Specifically, the automatic bread maker 1B has a grinding unit 70B which has a configuration in which the motor 73 is incorporated into the lid 30, rather than a configuration which allows the entire grinding unit including the motor (grinding motor) 73 to be pulled out from the lid 30 (configuration of the grinding unit 70A).

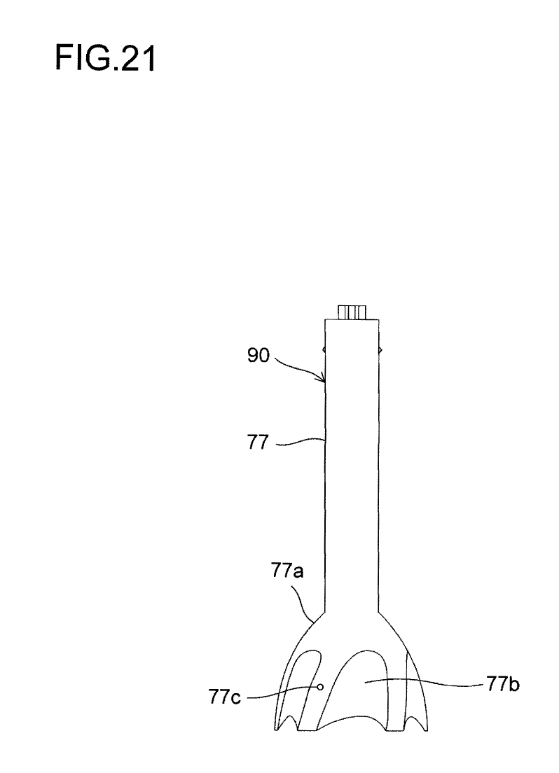

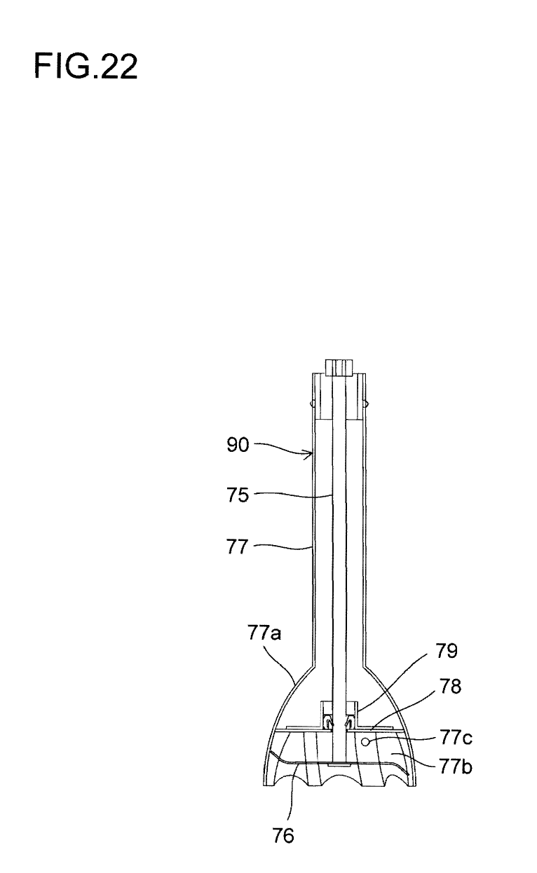

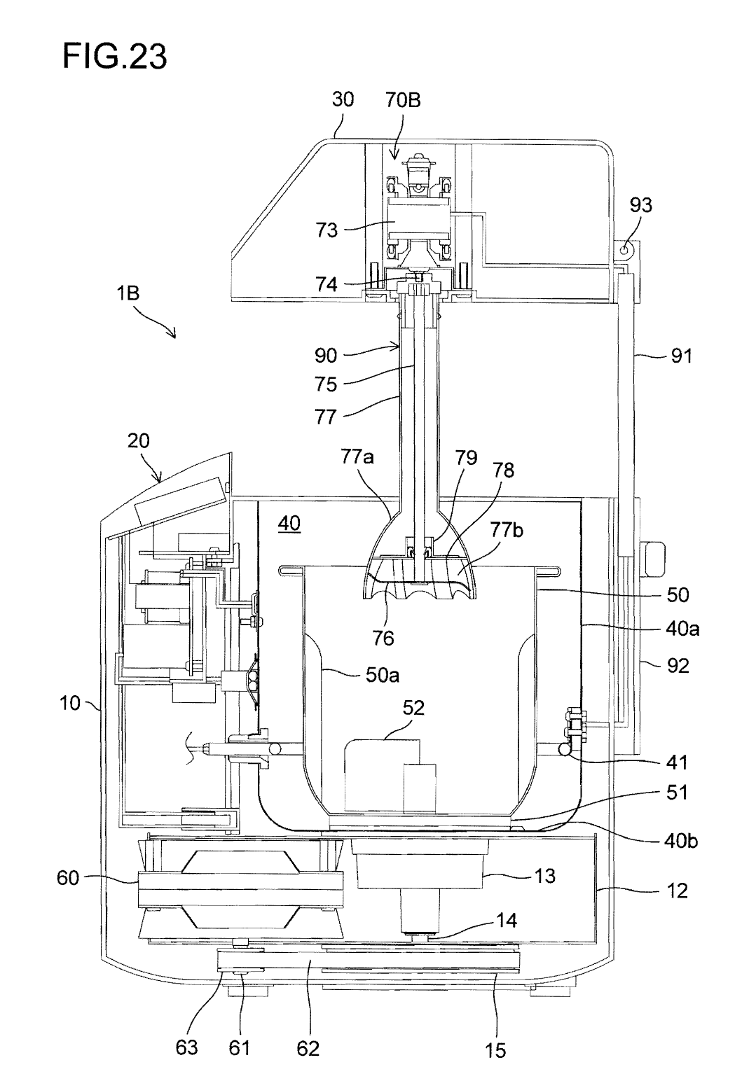

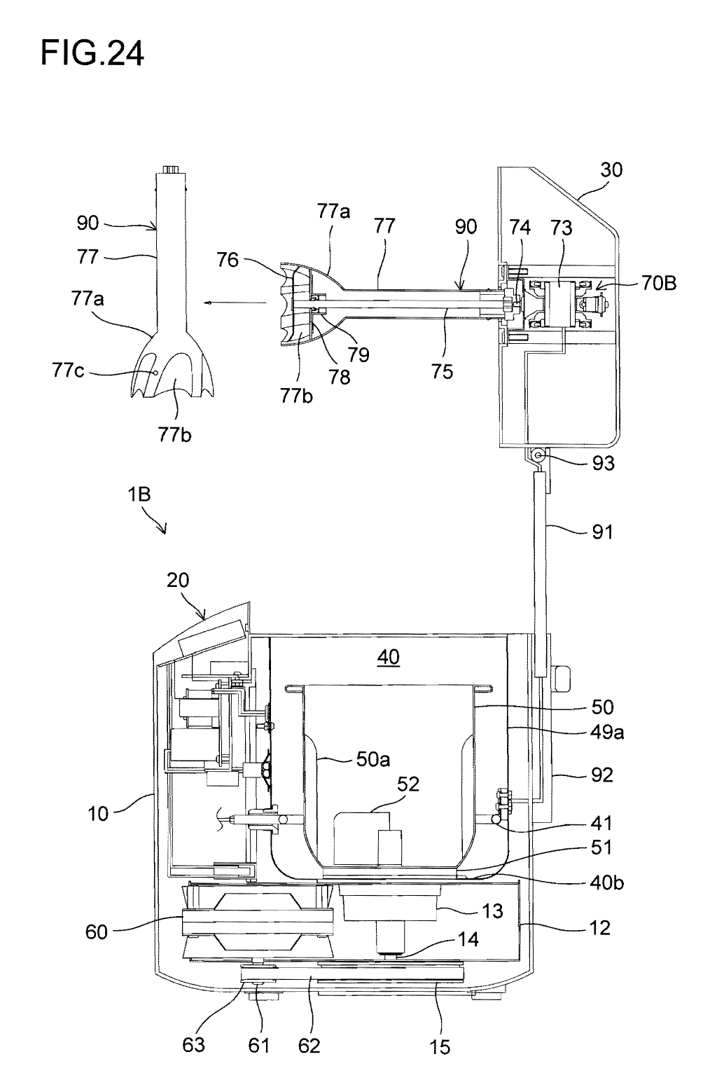

In the grinding unit 70B, the rotation shaft 75, the grinding blade 76, and the sheathing 77 form a grinding blade assembly 90 (see FIGS. 21 and 22) which may be coupled to the motor 73 in a detachable manner. Further, the lid 30 is configured not only to be turned in a vertical plane using a hinge shaft as a support point, but also to be lifted up along with the support point which itself moves upward (see FIGS. 23 and 24).

In order to lift up the lid 30, a lift up column 91 illustrated in FIG. 24 is provided to a back surface of the body 10. The lift up column 91 is sheathed into a guide 92 which is in a scabbard-like shape attached to the back surface of the body 10, and moves in a vertical direction. The lift up column 91 may be moved up and down by man power, or through the use of a motor or an air cylinder. Alternatively, there may be adopted a configuration in which the lift up column 91 may be biased upward by a spring, so that the lift up column 91 is held downward when the lift up column 91 is pressed down and locked, and when the lock is released, the lift up column 91 moves upward due to a tension of the spring, bringing the lid 30 into a lift up state. The lid 30 is attached to an upper end of the lift up column 91 via a hinge shaft 93.

In the automatic bread maker 1B, the lid 30 is lifted up as illustrated in FIG. 23 when taking out the bread container 50 from the baking chamber 40, or when installing the bread container 50 into the baking chamber 40. In the lift up state, the lid 30 is turned to an open position as illustrated in FIG. 24. In this manner, the grinding blade assembly 90 is placed sideways (the rotation shaft 75 is placed in a horizontal position), and hence the grinding blade assembly 90 may be coupled to and detached from the motor 73 with ease. When the grinding process #20 is ended, the lid 30 is lifted up and the grinding blade assembly 90 is detached, before the process proceeds to the mixing/kneading process #30.

Both in the first embodiment and in the modified example of the first embodiment, the rotation of the grinding blade 76 and the rotation of the mixing/kneading blade 52 may be controlled in association with each other by the single control device 80, and hence the grinding blade 76 and the mixing/kneading blade 52 each may be applied with rotation suited for the type and amount of the grains in a stage of grinding the grains and in a stage of mixing/kneading the ground grains, to thereby improve the quality of the bread.

### Second Embodiment

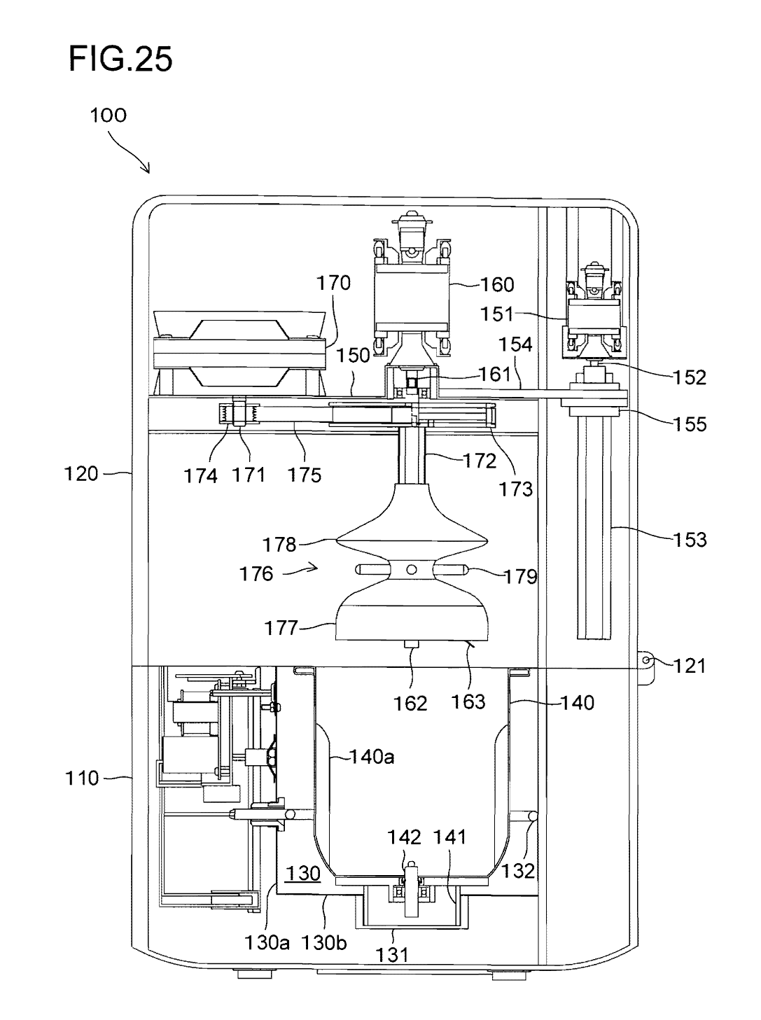

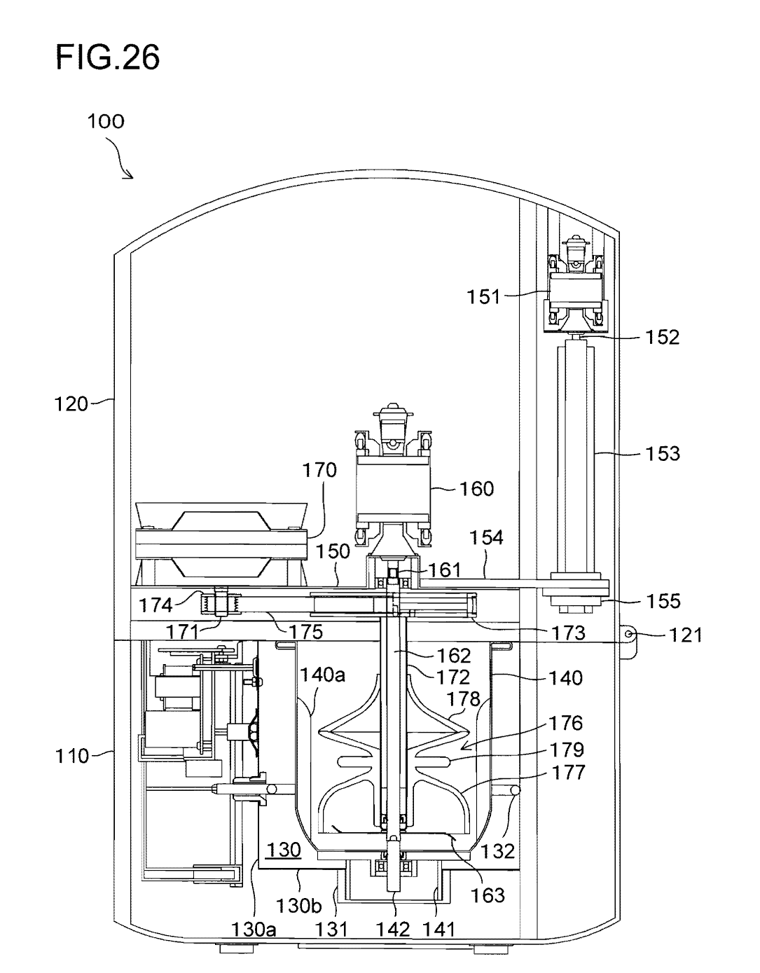

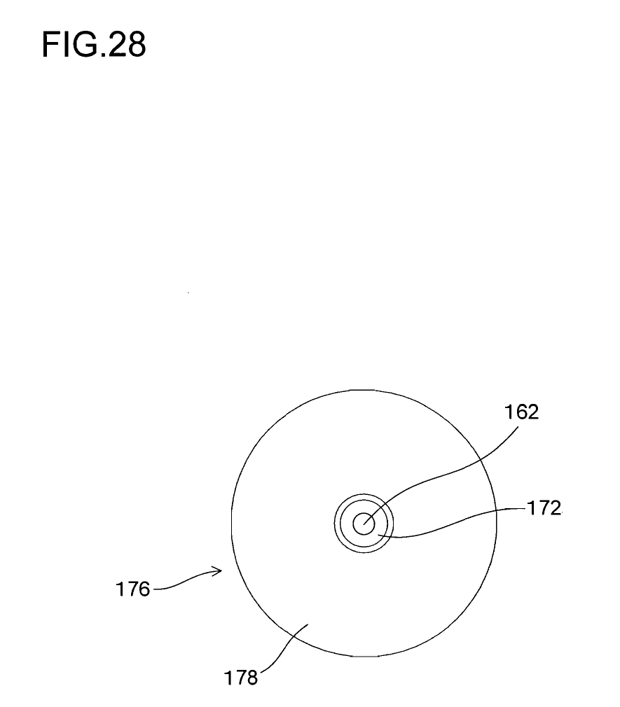

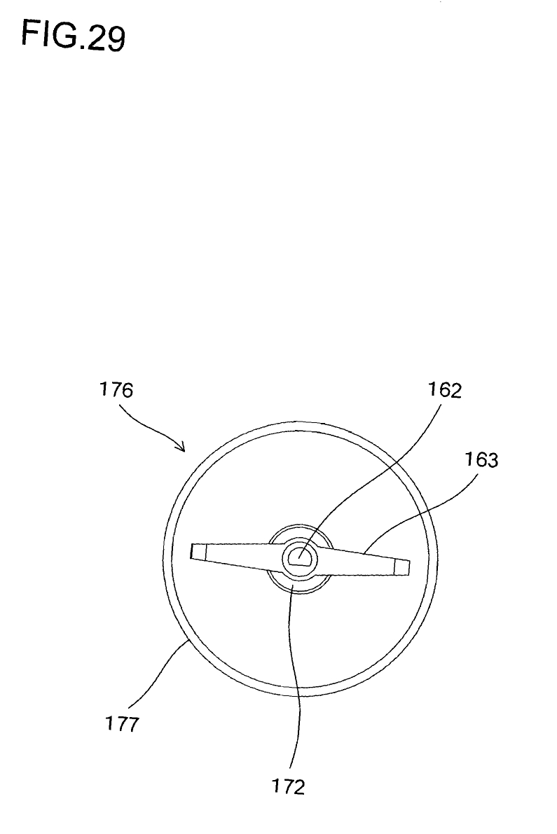

An automatic bread maker 100 according to a second embodiment of the present invention is described with reference to FIGS. 25 to 35. In FIGS. 25 and 26, a front surface side of the automatic bread maker 100 is on the left side of FIGS. 25 and 26, while a back surface (rear surface) side of the automatic bread maker 100 is on the right side of FIGS. 25 and 26.

As illustrated in FIGS. 25 and 26, the automatic bread maker 100 has a body 110 in a box shape provided with an outer shell made of a synthetic resin. The body 110 has an upper surface covered with a lid 120 made of a synthetic resin. The lid 120 is attached to an edge on a back surface side of the body 110 via a hinge shaft 121, and turns in a vertical plane using the hinge shaft 121 as a support point.

A baking chamber 130 is provided inside the body 110. The baking chamber 130 has a peripheral side wall 130a and a bottom wall 130b. The baking chamber 130 is similar in configuration to the baking chamber 40 of the first embodiment, which has a heating device 132 disposed therein for heating breadmaking materials, and also has a bread container support 131 fixed to the bottom wall 130b. The bread container support 131 is configured to support a bread container 140 by receiving a cylindrical pedestal 141 fixed to a bottom surface of the bread container 140.

Protrusions (not shown) are each formed on an inner peripheral surface of the bread container support 131 and on an outer peripheral surface of the pedestal 141, similarly to the bread container support 13 and the pedestal 51 of the first embodiment. The protrusions form a known bayonet coupling, as in the first embodiment. It should be noted that the bread container 140 to be mounted is twisted in a rotation direction of a mixing kneader to be described later, so that the bread container 140 may not be detached even when the mixing kneader is rotated.

The bread container 140 is substantially similar in configuration to the bread container 50 of the first embodiment. The bread container 140 has a convex portion 140a in a ridge shape extending in a vertical direction formed on an inner surface thereof. It should be noted that, unlike the configuration of the first embodiment, a vertical receiving shaft 142 is disposed at the center of the bottom of the bread container 140. The receiving shaft 142 is rotatably supported at the center of the bottom of the bread container 140 and is sealed against leakage, and has a small diameter portion formed at an upper end thereof.

A horizontal lifting deck (lifting part) 150 is provided inside the lid 120. The lifting deck 150 moves up and down along a guiding device (not shown) while keeping itself in a horizontal state. The lifting deck 150 is moved up and down by a lifting motor 151 disposed on the back surface side of the lid 120. The lifting motor 151 has a vertical shaft, and has a motor shaft 152 protruding downward. A feed screw 153 is fixed to the motor shaft 152, and the feed screw 153 is coupled to a nut 155 which is attached to a bracket 154 extending from the lifting deck 150. When the lifting motor 151 rotates the feed screw 153, the nut 155 is moved in the direction of axis of the feed screw 153, to thereby cause the lifting deck 150 to move up and down. In order to reduce a loss in power transmission, the feed screw 153 and the nut 155 may be formed of a ball screw and a ball nut, respectively, which are used in combination.

A grinding motor 160 and a mixing/kneading motor 170 are fixed onto an upper surface of the lifting deck 150. The grinding motor 160 and the mixing/kneading motor 170 both have a vertical shaft, and each have motor shafts 161 and 171 protruding downward, respectively. The motor shaft 161 is directly connected to a vertical rotation shaft 162 (see FIGS. 25 and 26), which is provided at a lower end thereof with a grinding blade 163.

A cylindrical shaft 172 is provided outside the rotation shaft 162, in a manner that the cylindrical shaft 172 is relatively rotatable with respect to the rotation shaft 162 while being relatively immovable in the direction of axis of the rotation shaft 162. A pulley 173 is fixed to an upper end of the cylindrical shaft 172. The pulley 173 is coupled to a pulley 174 which is fixed to the motor shaft 171, via a belt 175. The pulley 174 is configured to slow down the rotation of the pulley 173, so that the cylindrical shaft 172 is rotated at low speed with high torque.

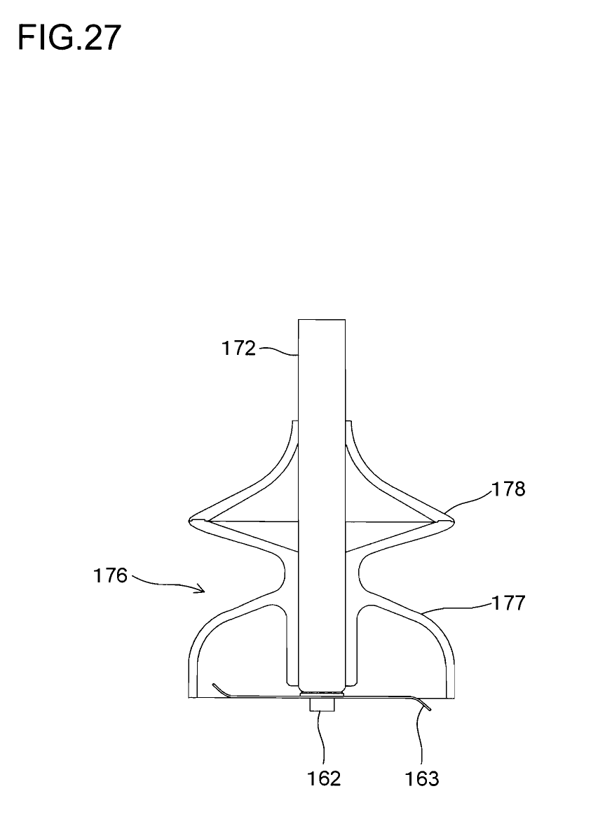

A mixing kneader 176 is fixed to the cylindrical shaft 172. The mixing kneader 176 (see also FIGS. 27 to 29) includes a dough kneading part 177 in a dorm shape surrounding the grinding blade 163 and the rotation shaft 162 which has the grinding blade 163 attached thereto, and a dough turning part 178 in the form of a rotational body provided above the dough kneading part 177. The dough kneading part 177 is formed in a slightly flattened hemispherical shape and the dough turning part 178 is formed in an abacus bead shape, which are substantially the same in diameter. The dough kneading part 177 and the dough turning part 178 have a constricted portion therebetween, from which a plurality of kneading arms (rod-like arms) 179 project in a radial fashion. The kneading arms 179 are retracted inwardly so that the tip ends thereof fall within the maximum diameters of the dough kneading part 177 and the dough turning part 178. The number of the kneading arms 179 is not specifically limited. However, if the kneading arms 179 are provided too many, the dough cannot be held therebetween. Accordingly, the number may be set to around two to four.

The mixing kneader 176 may be integrally formed from a synthetic resin or metal. Alternatively, the mixing kneader 176 may be configured with a combination of synthetic resin components, a combination of metal components, or a combination of synthetic resin components and metal components.

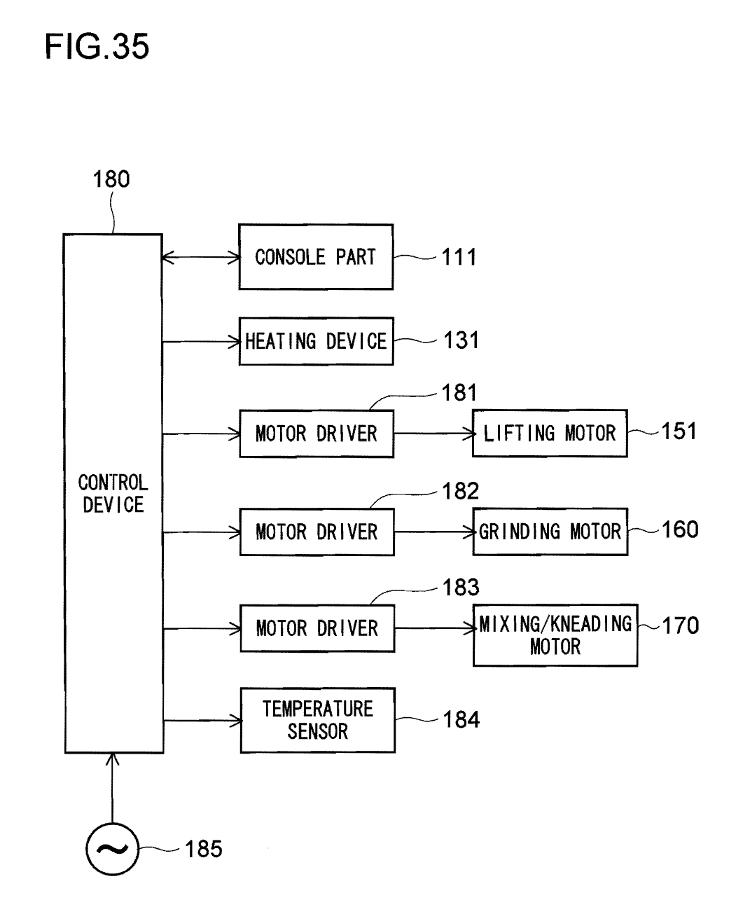

An operation of the automatic bread maker 100 is controlled by a control device 180 illustrated in FIG. 35. The control device 180 is formed of a circuit board disposed in appropriate place inside the body 110 (similarly to the first embodiment). The control device 180 is connected to the heating device 132, and is further connected to a console part 111 provided in appropriate place on a surface of the body 110, for example, on a front surface thereof, to a motor driver 181 for the lifting motor 151, to a motor driver 182 for the grinding motor 160, to a motor driver 183 for the mixing/kneading motor 170, and to a temperature sensor 184. The temperature sensor 184 is disposed inside the baking chamber 130, and detects temperature of the baking chamber 130. A commercial power source 185 supplies power to each constituent element.

The automatic bread maker 100 configured as described above is also capable of making bread from grains, similarly to the automatic bread maker 1A of the first embodiment, by following the breadmaking processes according to the first to third aspects (see FIGS. 10 to 18). In the following, an operation of making bread from grains by using the automatic bread maker 100 is described, mainly focusing on the difference from the first embodiment.

In the pre-grinding impregnation process #10 (see FIG. 11), operations of measuring the grains and the liquid in Steps #11 and #12 are basically similar to those in the first embodiment. In the following, the points of difference in Steps #11 and #12 are described.

When the automatic bread maker 100 is used, prior to opening the lid 120 in order to take out or install the bread container 140 or in order to put grains and a liquid to the bread container 140 placed inside the baking chamber 130, the lifting deck 150 is set in an ascent position as illustrated in FIG. 25, with the rotation shaft 162, the grinding blade 163, and the mixing kneader 176 being placed inside the lid 120 without protruding outside therefrom.

The lid 120 is closed after grains and a liquid are put into the bread container 140 placed inside the baking chamber 130, or after the bread container 140, which contains grains and a liquid put thereinto outside the baking chamber 130, is installed into the baking chamber 130. Then, the following operation is performed. After the lid 120 is closed, the lifting deck 150 is moved down, and the rotation shaft 162, the grinding blade 163, and the mixing kneader 176 gradually go down into the bread container 140 as hanging down from the above. When the lifting deck 150 is further moved down to the limit, as illustrated in FIG. 26, a concave portion formed in a lower end surface of the rotation shaft 162 engages with the small diameter portion formed at the upper end of the receiving shaft 142. This configuration prevents runout of the rotation shaft 162 at the lower end thereof. After the engagement, the receiving shaft 142 rotates integrally with the rotation shaft 162. Further, at this point, the grinding blade 163 and the dough kneading part 177 are placed close to the bottom of the bread container 140.

Following Step #12, Step #13 for still standing and Step #14 for checking time are performed similarly as in the case of the first embodiment.

Following the pre-grinding impregnation process #10, the grinding process #20 (see FIG. 12) is started by an operation similar to that of the first embodiment. In Step #21, the control device 180 drives the grinding motor 160, to thereby rotate the rotation shaft 162. As a result, the grinding blade 163 starts rotation in the mixture of the grains and the liquid. The mixing kneader 176 is not in operation. The grains to be ground by the grinding blade 163 are impregnated beforehand with the liquid, and therefore the grains may be easily ground to the core.

In the manner as described above, during the rotation of the grinding blade 163, the grains in the bread container 140 go into the dough kneading part 177 together with the liquid through a gap between the dough kneading part 177 and the inner bottom surface of the bread container 140 to be ground by the grinding blade 163, and go out of the dough kneading part 177, in a repetitive manner, so that the grains are ground down into small pieces.

It should be noted that Step #22 for checking whether or not the set grinding pattern is carried through and Step #23 for stopping rotation of the grinding blade 163 are performed similarly as in the case of the first embodiment.

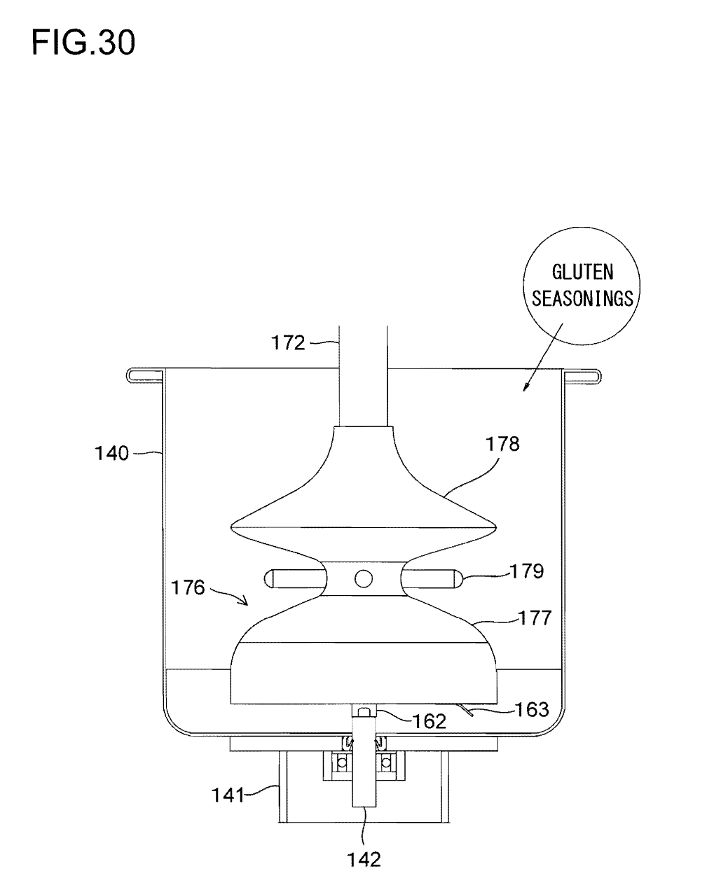

Following the grinding process #20, the mixing/kneading process #30 (see FIG. 13) is performed. As in the case of the first embodiment, prior to the rotation of the mixing kneader 176 (which does not have the mixing/kneading blade in this embodiment), the preparation operations in Step #31 (including: an operation to add gluten and seasonings; an operation to set the console part 111; and an operation to press the start key) are performed (see FIG. 30).

In Step #32, the control device 180 drives the mixing/kneading motor 170. As a result, the mixing kneader 176 starts rotation in the dough material. Further, the control device 180 energizes the heating device 132 as necessary, to thereby increase the temperature of the baking chamber 130. Along with the rotation of the mixing/kneading blade 176, the dough material is further mixed and kneaded by the dough kneading part 177 to be turned into dough which comes together and exhibits a predetermined degree of elasticity.

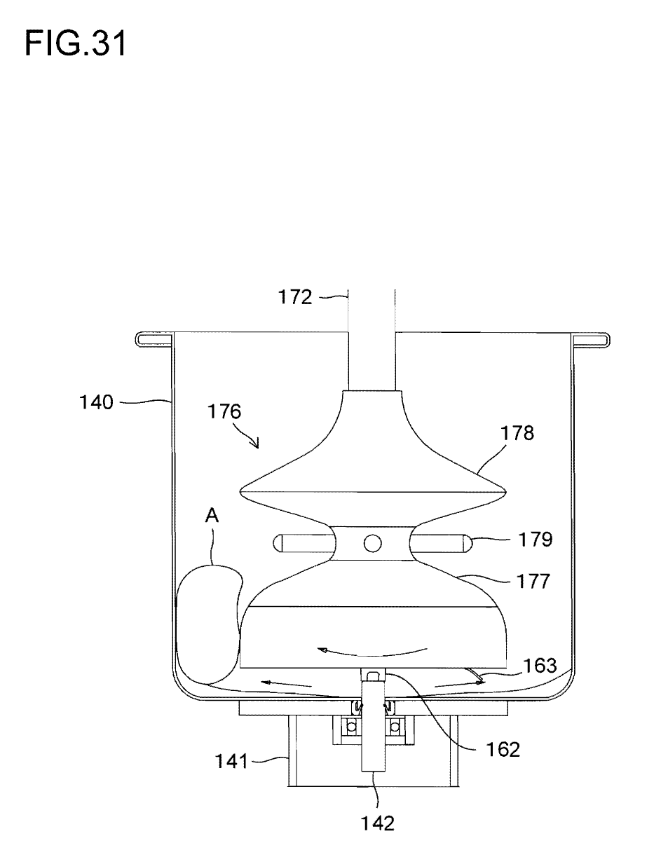

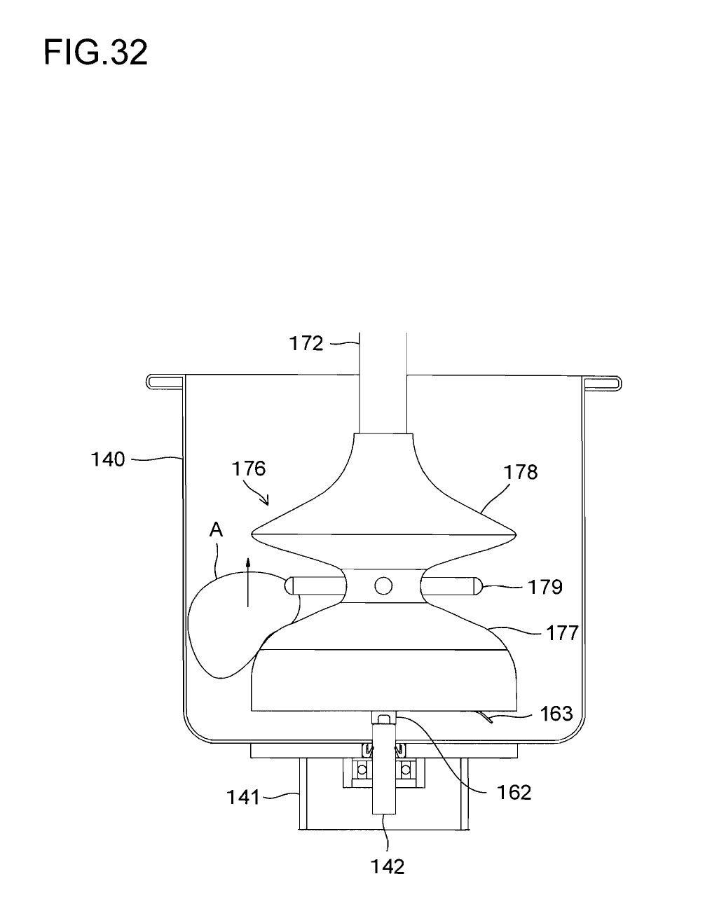

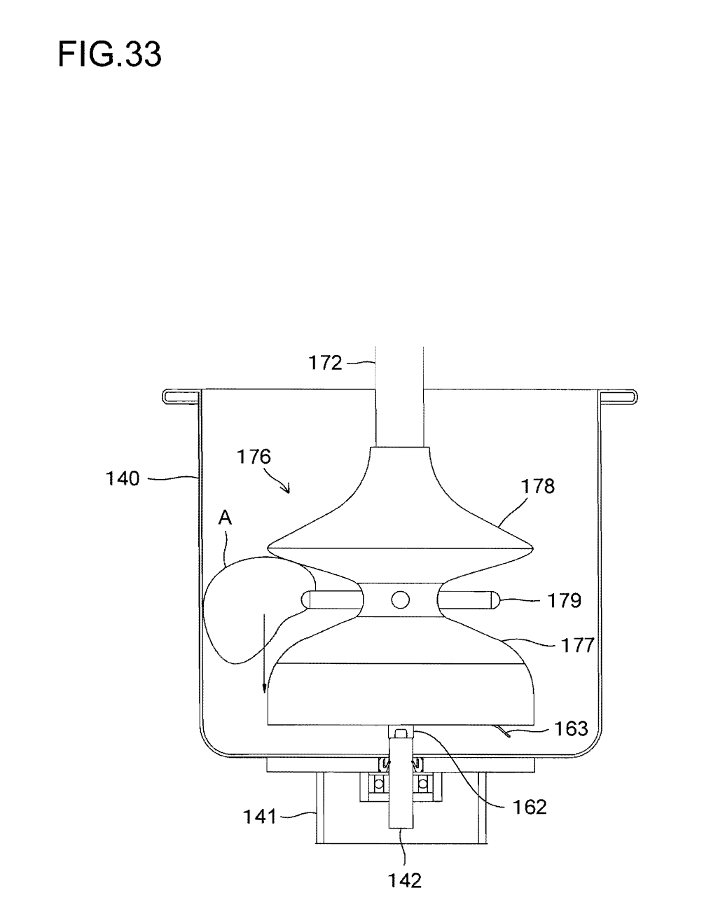

As illustrated in FIGS. 31 and 32, dough A tends to make its way up onto an upper surface of the dough kneading part 177 from an outer periphery of the dough kneading part 177. Due to the dough turning part 178 lying thereabove, the dough A moving upward is held down to stay within certain limits. The kneading arm 179 catches the dough A in this state, as illustrated in FIG. 33, so that the dough A is made to reliably follow the movement of the mixing kneader 176, and hence the dough A may be kneaded sufficiently. The convex portions 140a formed on the inner walls of the bread container 140 help the kneading.

Step #33 for checking time, Step #34 for adding yeast, Step #35 for checking time, and Step #36 for stopping rotation of the mixing kneader 176 are performed following Step #32, similarly as in the first embodiment.

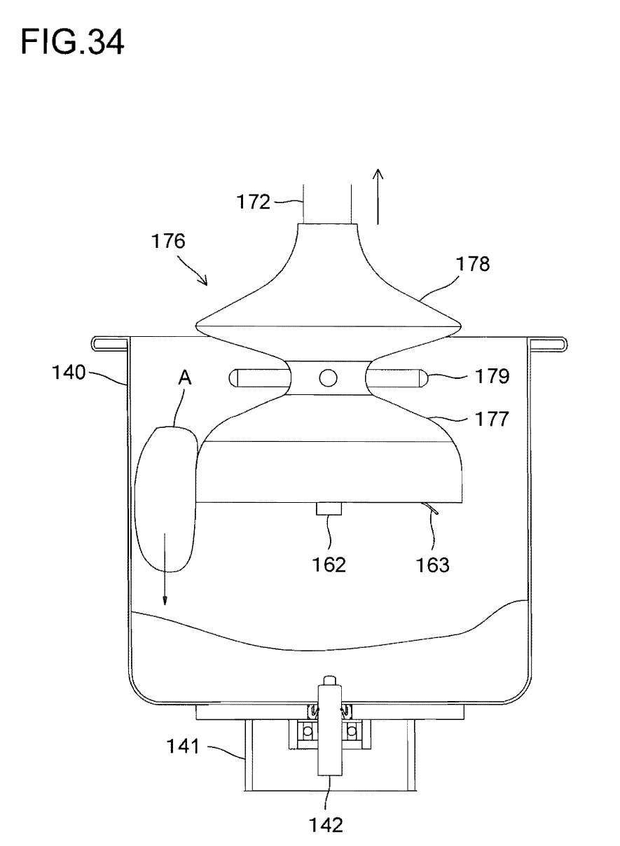

After the rotation of the mixing kneader 176 is stopped, the control device 180 drives the lifting motor 151 to move up the lifting deck 150. The rotation shaft 162, the grinding blade 163, and the mixing kneader 176 are pulled out from the bread container 140 as illustrated in FIG. 34. The dough A slips through between the outer peripheral surface of the dough kneading part 177 and the inner peripheral surface of the bread container 140 to fall onto the bottom of the bread container 140. When baking the dough A, the rotation shaft 162, the grinding blade 163, and the mixing kneader 176 are not contained in the dough A, and hence the dough A may be baked into bread with no trace of the rotation shaft 162, the grinding blade 163, and the mixing kneader 176, which improves the appearance of the bread.

Following the mixing/kneading process #30, the fermentation process #40 (FIG. 14) and the baking process #50 (FIG. 15) are sequentially performed similarly as in the first embodiment. Further, the operation in the post-grinding impregnation process #60 (FIG. 17) in the breadmaking process according to the second and third aspects is similarly performed as in the first embodiment.

It should be noted that the grinding blade 163 may also be used for pulverizing fillings such as nuts and leaf vegetables into small particles, as well as for grinding grains. Accordingly, bread with finely-ground fillings may be baked. The grinding blade 163 may also be used for pulverizing foodstuffs and herbal medicines, other than the fillings to be mixed into bread.

Further, the rotation of the grinding blade 163 and the mixing kneader 176 may be controlled in association with each other by the single control device 180, to thereby improve the quality of the bread similarly to the first embodiment.

### Third Embodiment

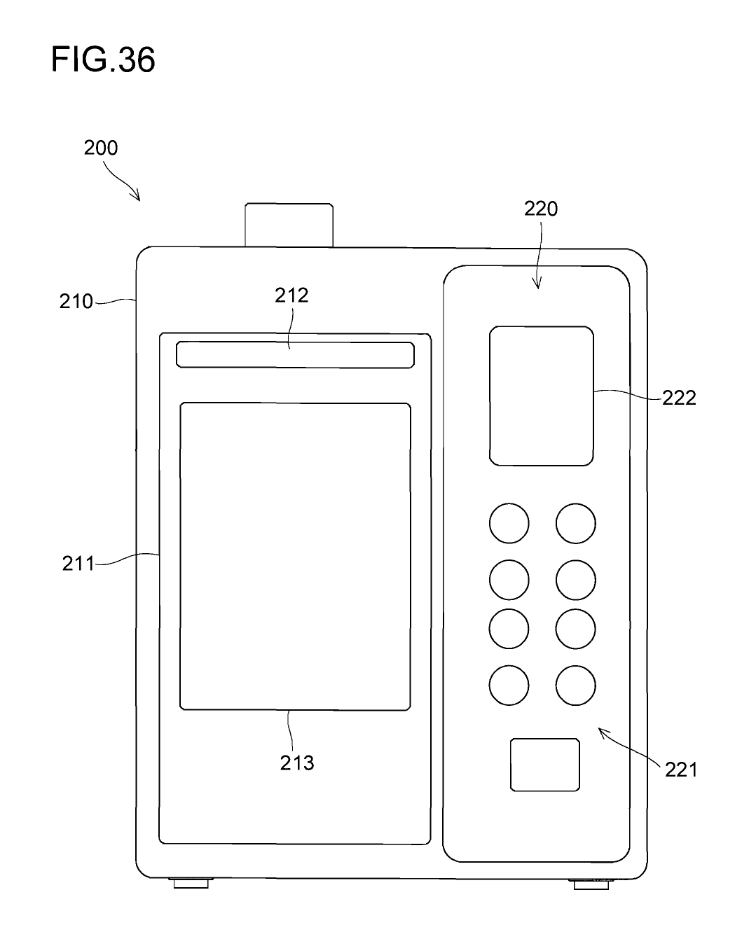

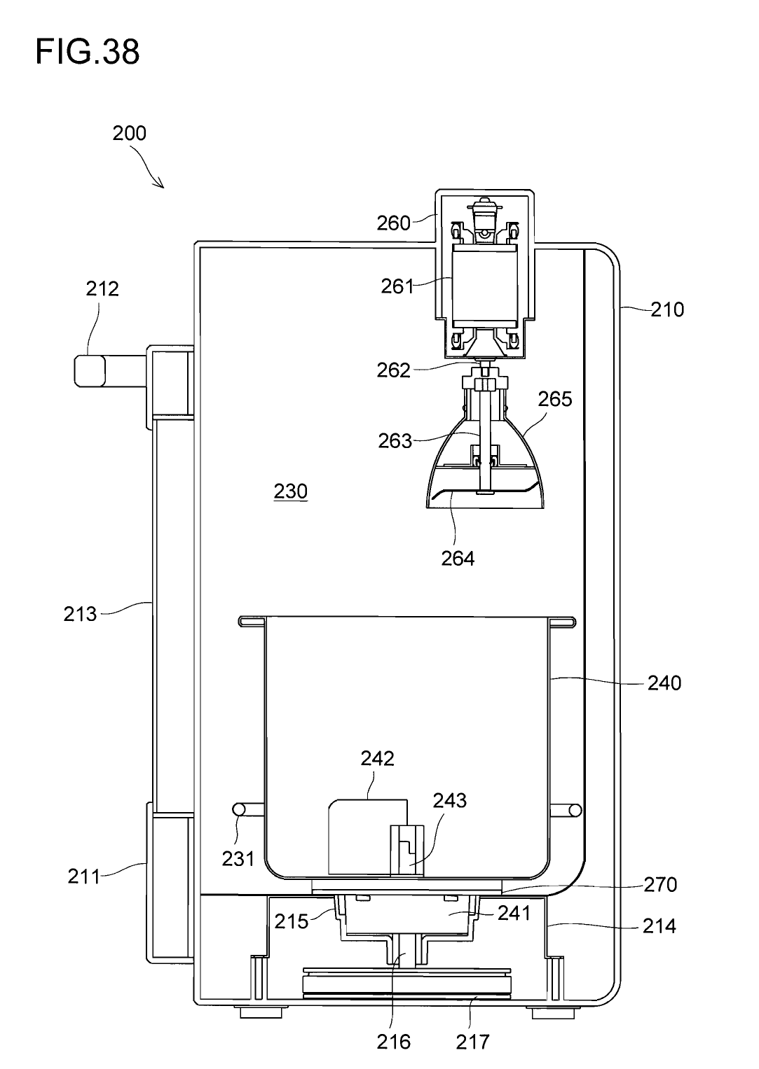

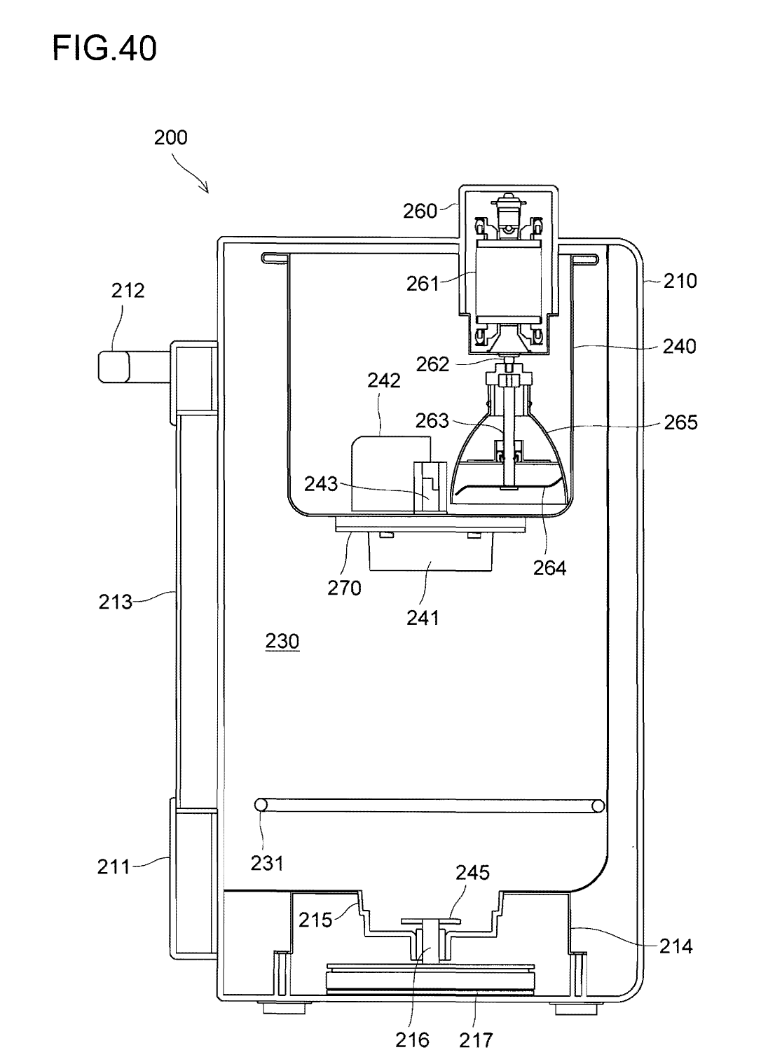

An automatic bread maker 200 according to a third embodiment of the present invention is described with reference to FIGS. 36 to 41. In FIGS. 38 and 40, a front surface side of the automatic bread maker 200 is on the left side of FIGS. 38 and 40, while a back surface (rear surface) side of the automatic bread maker 200 is on the right side of FIGS. 38 and 40. Further, the left side of the automatic bread maker 200 falls on the left-hand side of an observer facing the automatic bread maker 200 in front thereof, and the right side of the automatic bread maker 200 falls on the right-hand side of the observer.

The automatic bread maker 200 has a body 210 in a box shape. The body 210 is provided with an opening and a door 211 for closing the opening (see FIG. 36). The opening is provided on the left side of the front surface of the body 210 and leads to a baking chamber to be described later. The door 211 turns in a vertical plane using the lower edge as a support point, and has a handle 212 on an upper edge and an observation window 213 at a position below the handle 212. A pane of heat-resistant glass is fit into the observation window 213.

On the front surface of the body 210, a console part 220 is formed on a right side of the door 211 (see FIG. 36). The console part 220 is provided with an operation key group 221 and a display part 222 (which is formed of, for example, a liquid crystal display panel) similarly to the first embodiment.

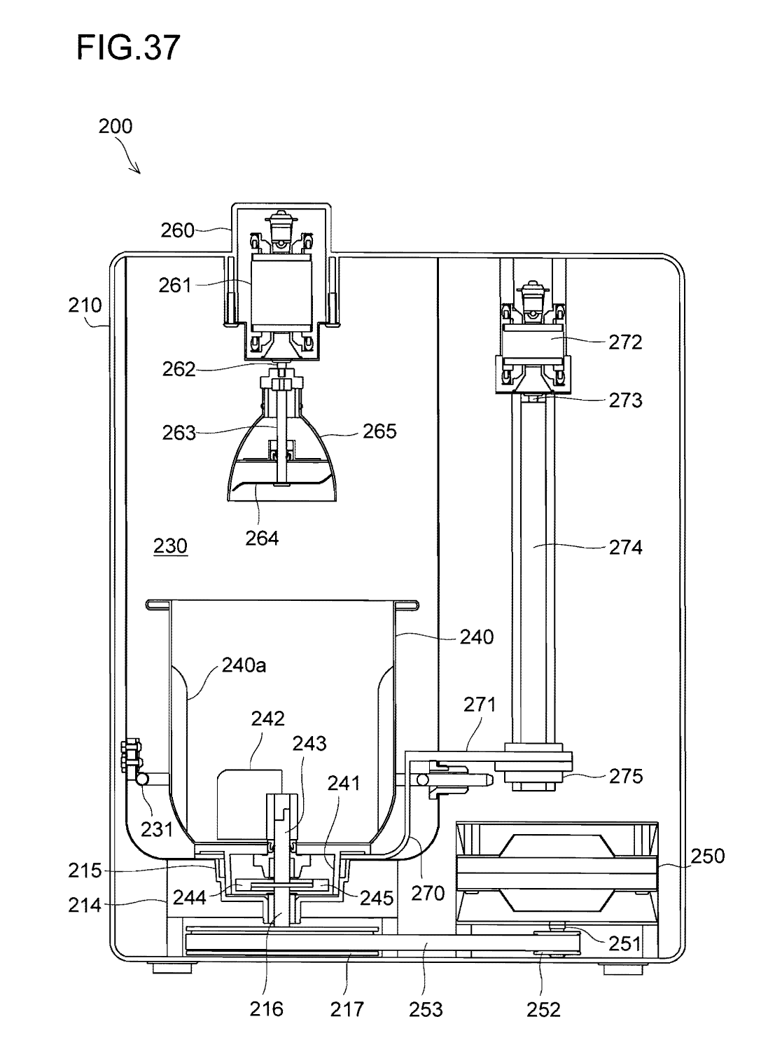

In the body 210, a baking chamber 230 for receiving a bread container 240 is provided on the rear side of the door 211 (see, for example, FIGS. 37 and 38). The baking chamber 230 has side walls and a bottom wall made of a sheet metal. Similarly to the baking chamber 40 of the first embodiment, a heating device 231 for heating breadmaking materials is disposed inside the baking chamber 230.

A base 214 made of a sheet metal is provided below the baking chamber 230. The base 214 has a bread container support 215 fixed thereto, at a position in the center of the baking chamber 230. The bread container support 215 is a die-cast component of an aluminum alloy. The bread container support 215 has its inside exposed to the inside of the baking chamber 230 via an opening formed in the bottom wall of the baking chamber 230.

The bread container support 215 supports, at the center thereof, a drive shaft 216 vertically. The drive shaft 216 protrudes, at a lower end thereof, from a lower surface of the bread container support 215, and a pulley 217 is fixed to the lower end of the drive shaft 216. The bread container support 215 receives a cylindrical pedestal 241 fixed to a bottom surface of the bread container 240, to thereby support the bread container 240. The pedestal 241 is also a die-cast component of an aluminum alloy.

The bread container 240 is similar in configuration to the bread container 50 of the first embodiment. The bread container 240 has a convex portion 240a in a ridge shape extending in a vertical direction formed on an inner surface thereof, and a mixing/kneading blade 242 disposed at the center of the bottom thereof. Similarly to the first embodiment, the mixing/kneading blade 242 is attached by being simply engaged with a noncircular section at an upper end of the blade attachment shaft (blade rotation shaft) 243 which is supported at the center of the bottom of the bread container 240 and is sealed against leakage.

The blade attachment shaft 243 is coupled to the drive shaft 216 and receives power transmitted therefrom. In order to attain the power transmission, a coupling member 244 is fixed to a lower end of the blade attachment shaft 243, while a coupling member 245 to be coupled to the coupling member 244 is fixed to an upper end of the drive shaft 216.

A mixing/kneading motor 250 is disposed inside the body 210. The mixing/kneading motor 250 has a vertical shaft, and a motor shaft 251 protrudes from a lower surface of the mixing/kneading motor 250. A pulley 252 is fixed to the motor shaft 251, and the pulley 252 is coupled to a pulley 217 of the drive shaft 216 via a belt 253. The pulley 252 is configured to slow down the rotation of the pulley 217, so that the drive shaft 216 is rotated at low speed with high torque.

In a ceiling of the baking chamber 230, a motor chamber 260 is formed, in which a grinding motor 261 is disposed. The motor chamber 260 protrudes halfway up from a top surface of the body 210. The grinding motor 261 has a vertical axis, and has a motor shaft 262 protruding downward therefrom. A vertical rotation shaft 263, which is provided with a grinding blade 264 at a lower end thereof, is directly coupled to the motor shaft 262. The rotation shaft 262 and the grinding blade 264 are configured to hang down from the grinding motor 261 (from the above of the baking chamber 230).

A sheathing 265 surrounds the rotation shaft 263 and the grinding blade 264. The sheathing 265 is a cylindrical member made of a sheet metal such as a stainless steel plate. A lower end of the sheathing 265, that is, a portion surrounding the grinding blade 264 is formed to be larger in diameter than the rest portion, and is bulged in a shape like an upper half of an eggshell.

An elevator (lifting part) 270 is disposed inside the baking chamber 230. The elevator 270 supports and lifts up the bread container 240 from below. The elevator 270 is a metal component which has a through hole for receiving a pedestal 241 to be fit thereinto. The elevator 270 has a bracket 271, which extends horizontally, formed on one end thereof. A hole elongated in a vertical direction for having the bracket 271 pass therethrough is formed in a side wall of the baking chamber 230. A lifting motor 272 is provided to a ceiling of the body 210, so as to be located above the bracket 271. The lifting motor 272 has a vertical shaft, and has a motor shaft 273 protruding downward therefrom. The motor shaft 273 has a feed screw 274 fixed thereto. The feed screw 274 is coupled to a nut 275 attached to the bracket 271. When the lifting motor 272 rotates the feed screw 274, the nut 275 is moved in the direction of axis of the feed screw 274, to thereby cause the elevator 270 to move up and down. In order to reduce a loss in power transmission, the feed screw 274 and the nut 275 may be formed of a ball screw and a ball nut, respectively, which are used in combination.

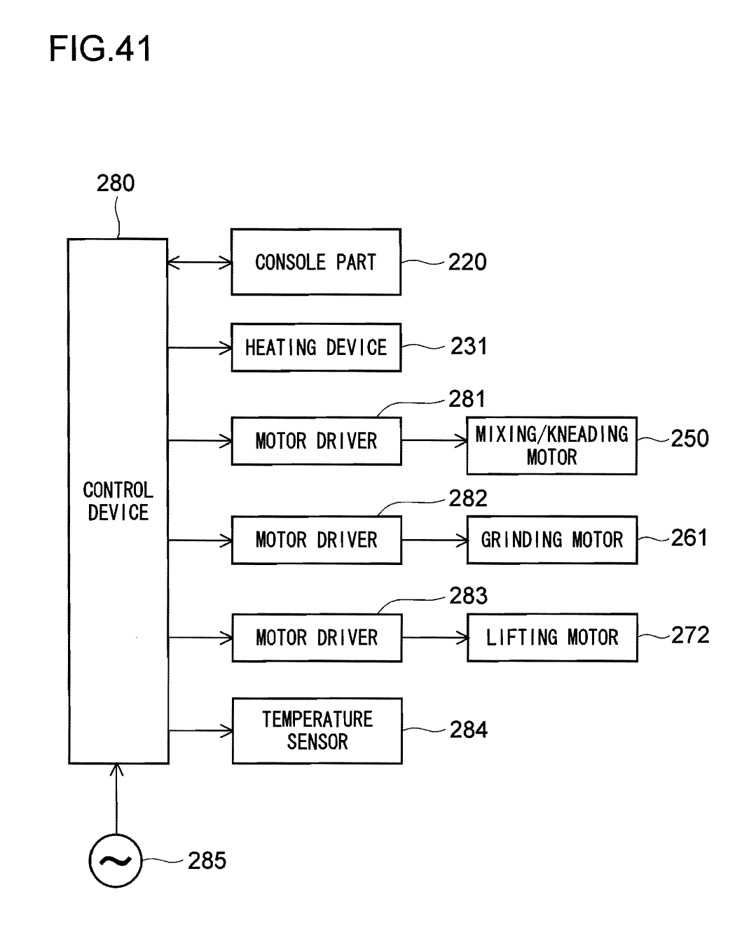

An operation of the automatic bread maker 200 is controlled by a control device 280 illustrated in FIG. 41. The control device 280 is formed of a circuit board disposed in appropriate place inside the body 210 (similarly to the first embodiment). The control device 280 is connected to a console part 220 and the heating device 231, and is further connected to a motor driver 281 for the lifting motor 250, to a motor driver 282 for the grinding motor 261, to a motor driver 283 for the mixing/kneading motor 272, and to a temperature sensor 284. The temperature sensor 284 is disposed inside the baking chamber 230, and detects temperature of the baking chamber 230. A commercial power source 285 supplies power to each constituent element.

The automatic bread maker 200 configured as described above is also capable of making bread from grains, similarly to the automatic bread maker 1A of the first embodiment, by following the breadmaking processes according to the first to third aspects (see FIGS. 10 to 18). In the following, an operation of making bread from grains by using the automatic bread maker 200 is described, mainly focusing on the difference from the first embodiment.

In the pre-grinding impregnation process #10 (see FIG. 11), operations of measuring the grains and the liquid in Steps #11 and #12 are basically similar to those in the first embodiment. In the following, the points of difference in Steps #11 and #12 are described.

When the automatic bread maker 200 is used, the bread container 240 may be taken out from the baking chamber 230 through the door 211 which is opened, so that grains and a liquid may be put into the bread container 240 outside the baking chamber 230. Alternatively, grains and a liquid may be put into the bread container 240 placed inside the baking chamber 230, through the door 211 opened. At this time, the elevator 270 is set in a descent position as illustrated in FIGS. 37 and 38. When grains and a liquid are put into the bread container 240 inside the baking chamber 230, or when the bread container 240, which contains grains and a liquid put thereinto outside the baking chamber 230, is installed into the baking chamber 230, the door 211 is closed.

Following Step #12, Step #13 for still standing and Step #14 for checking time are performed similarly as in the case of the first embodiment.

Following the pre-grinding impregnation process #10, the grinding process #20 (see FIG. 12) is started after a preparatory operation (of inputting data on the grinding operation and pressing the start key) similar to that of the first embodiment. However, unlike in the case of the first embodiment, the control device 280 drives the lifting motor 272 to move up the elevator 270, before starting the rotation of the grinding blade 264.

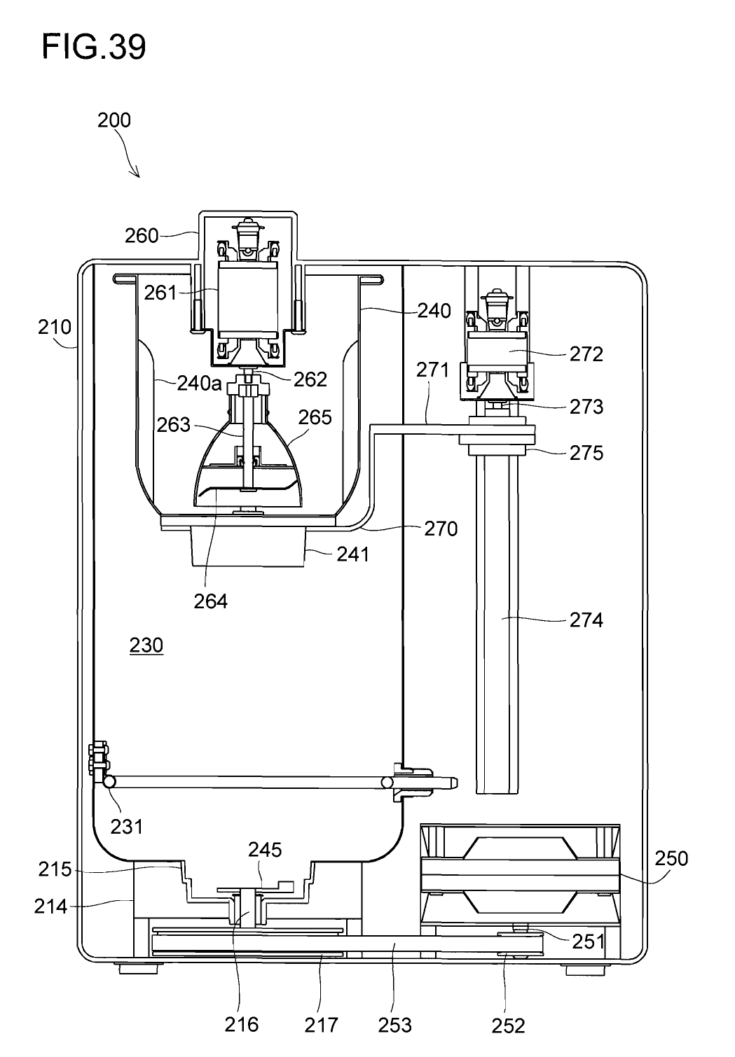

The elevator 270 is moved up to a position (grinding position) where the grinding blade 264 comes close to the bottom of the bread container 240, as illustrated in FIGS. 39 and 40. When the elevator 270 is stopped, the grinding blade 264 and the sheathing 265 are placed close to an inner bottom surface of the bread container 240 at a predetermined distance. At this time, the mixing/kneading blade 242 is turned in advance to a direction of avoiding contact with the grinding blade 264 and the sheathing 265. Alternatively, an origin position of the mixing/kneading blade 242 may be set to a position of avoiding contact with the sheathing 265, and the mixing/kneading blade 242 may be configured to always stop at the origin position after rotation.

In Step #21, the control device 280 drives the grinding motor 261, to thereby rotate the rotation shaft 263. In this manner, the grinding blade 264 starts rotation in the mixture of the grains and the liquid. The grains to be ground by the grinding blade 264 are impregnated beforehand with the liquid, and therefore the grains may be easily ground to the core.

In the manner as described above, during the rotation of the grinding blade 264, the grains in the bread container 240 go into the sheathing 265 together with the liquid through a gap between the sheathing 265 and the inner bottom surface of the bread container 240 to be ground by the grinding blade 264, and go out of the sheathing 265, in a repetitive manner, so that the grains are ground down into small pieces.

It should be noted that Step #22 for checking whether or not the set grinding pattern is carried through and Step #23 for stopping rotation of the grinding blade 264 are performed similarly as in the case of the first embodiment. However, in the automatic bread maker 200, the following operation is performed after the rotation operation of the grinding blade 264.

Specifically, when the rotation of the grinding blade 264 is ended, the elevator 270 is moved down to a position illustrated in FIGS. 37 and 38, so that the bread container 240 is brought down to be placed at a bottom of the baking chamber 230, to thereby reestablish the coupling between the coupling members 244 and 245. After that, the grinding process #20 is ended. An operation of ending the grinding process is similarly performed as in the first embodiment.

The mixing/kneading process #30 (FIG. 13), the fermentation process #40 (FIG. 14), and the baking process #50 (FIG. 15) are sequentially performed following the grinding process #20, in the same manner as in the first embodiment. Further, the operation in the post-grinding impregnation process #60 (FIG. 17) in the bread making process according to the second and third aspects is similarly performed as in the first embodiment.

It should be noted that the third embodiment is similar to the second embodiment in that the grinding blade 264 may be used for a purpose other than grinding grains (such as, for pulverizing fillings such as nuts into small particles, or for pulverizing foodstuffs and herbal medicines other than the fillings to be mixed into bread). Further, the third embodiment is also similar to the first and second embodiments in that the rotation of the grinding blade 264 and the rotation of the mixing/kneading blade 242 may be controlled in association with each other by the single control device 280 so that the quality of the bread is improved.

### Fourth Embodiment

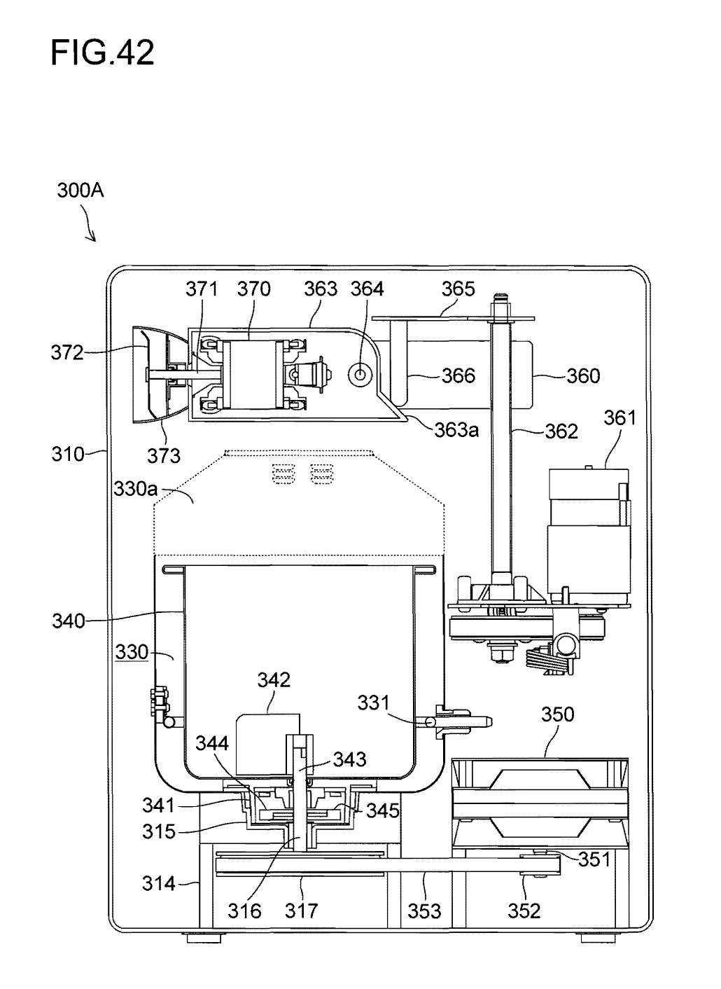

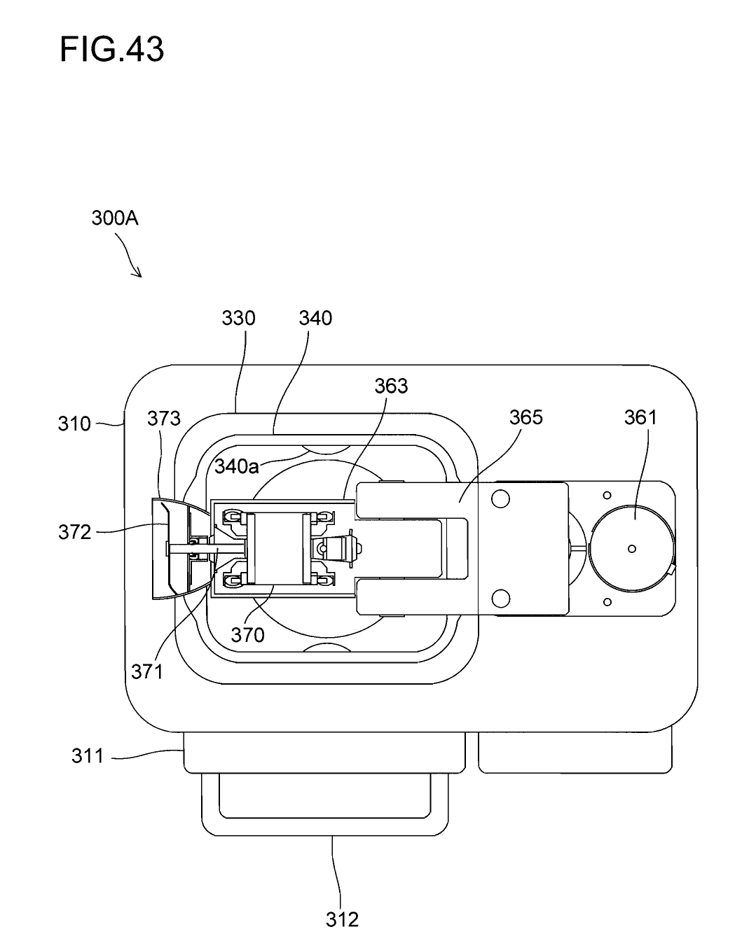

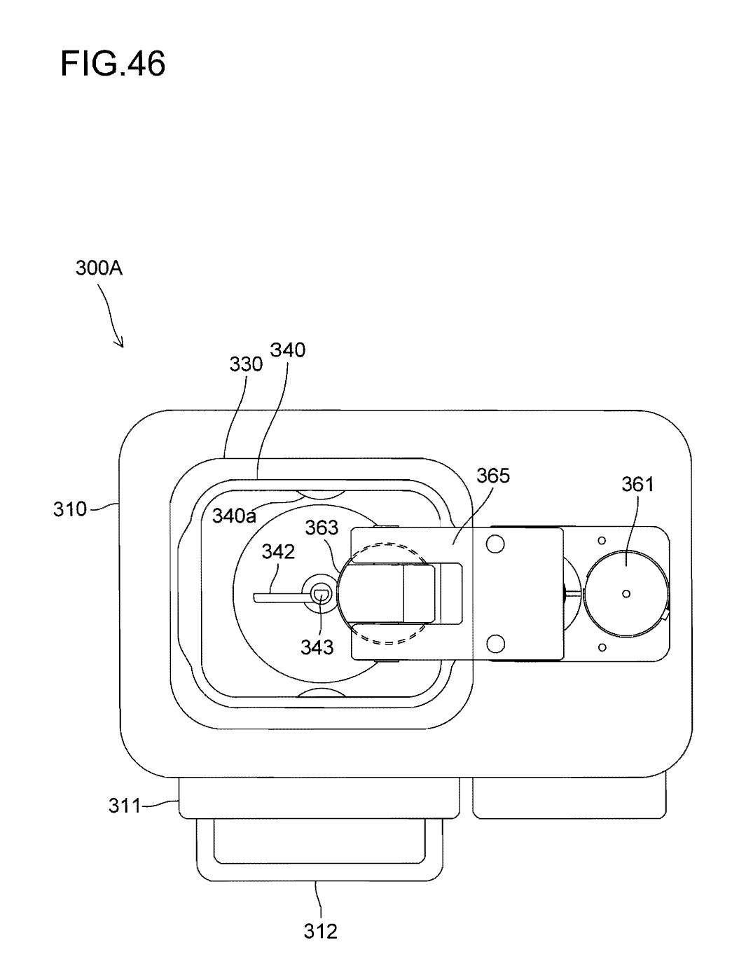

An automatic bread maker 300A according to a fourth embodiment of the present invention is described with reference to FIGS. 42 to 47. In FIG. 43, a front surface side of the automatic bread maker 300A is on the lower side of FIG. 43, while a back surface (rear surface) side of the automatic bread maker 300A is on the upper side of FIG. 43. Further, the left side of the automatic bread maker 300A falls on the left-hand side of an observer facing the automatic bread maker 300A in front thereof, and the right side of the automatic bread maker 300A falls on the right-hand side of the observer.

The automatic bread maker 300A has a body 310 in a box shape. The body 310 is provided with an opening and a door 311 for closing the opening (see FIG. 43). The opening is provided on the left side of the front surface of the body 310 and leads to a baking chamber 330 to be described later. The door 311 turns in a vertical plane using the lower edge as a support point, and has a handle 312 attached on an upper edge thereof.

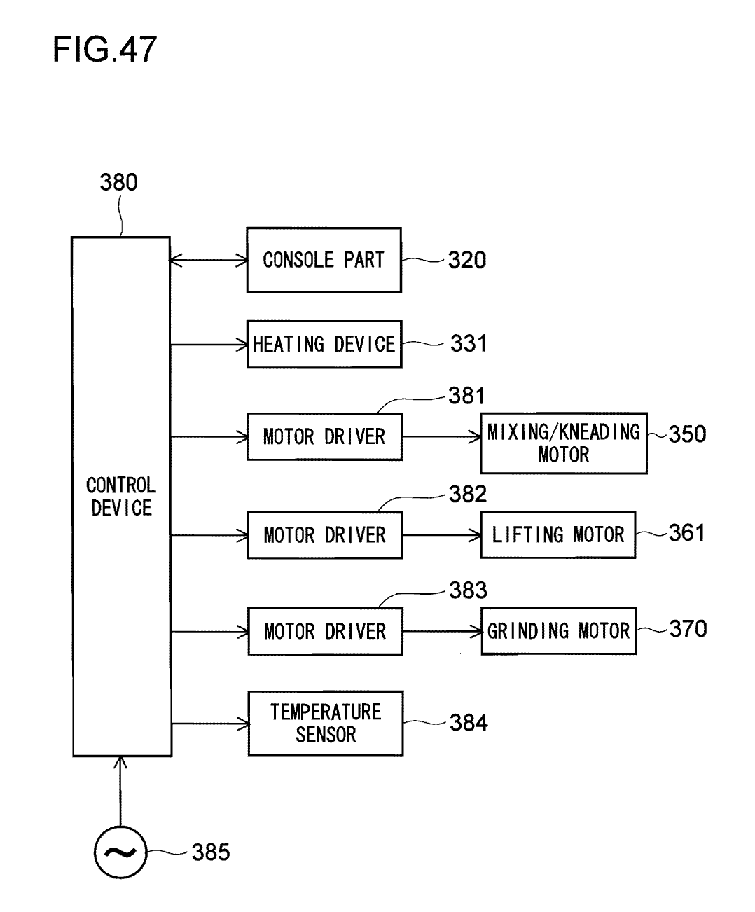

A console part 320 illustrated in FIG. 47 is provided in part of an external surface of the body 310 (for example, the same configuration as that of the automatic bread maker 200 according to the third embodiment (see FIG. 36) may be employed). The console part 320 is provided with, similarly to the first embodiment, an operation key group and a display part which is formed of, for example, a liquid crystal display panel.

In the body 310, a baking chamber 330 for receiving a bread container 340 is provided on the rear side of the door 311. The baking chamber 330 has side walls and a bottom wall made of a sheet metal (example of a heat resistance material). Similarly to the baking chamber 40 of the first embodiment, a heating device 331 for heating breadmaking materials is disposed inside the baking chamber 330. It should be noted that the baking chamber 330 may be configured to have an open upper surface thereof. However, it is preferable to provide a shielding lid 330a as illustrated by the short dashed line of FIG. 42 or the like. When the shielding lid 330a is provided, the shielding lid 330a on the opened upper surface of the baking chamber 330 may be configured to be opened and closed by a motor or the like (not shown).

Further, a base 314 is provided below the baking chamber 330, similarly as in the case of the automatic bread maker 200 of the third embodiment. A bread container support 315 is fixed to the base 314. Similarly to the third embodiment, a drive shaft 316 is vertically supported at the center of the bread container support 315. A configuration (including a pulley 317, a mixing/kneading motor 350, a motor shaft 351, a pulley 352, and a belt 353) for driving the drive shaft 316 is similar to that of the third embodiment.

Further, protrusions (not shown) are each formed on an outer peripheral surface of a bread container support 315 for receiving a cylindrical pedestal 341 fixed to a bottom surface of the bread container 340 and an outer peripheral surface of the cylindrical pedestal 341 similarly to the bread container support 13 and the pedestal 51 of the first embodiment. The protrusions form a known bayonet coupling similarly as in the first embodiment. It should be noted that the bread container 340 to be mounted is twisted in a rotation direction of the mixing/kneading blade 342, so that the bread container 340 may not be detached even when the mixing/kneading blade 342 is rotated.

The bread container 340 is similar in configuration to the bread container 50 of the first (third) embodiment. The bread container 340a has a convex portion 340a in a ridge shape extending in a vertical direction formed on an inner surface thereof, and a mixing/kneading blade 342 disposed at the center of the bottom thereof. Similarly to the first (third) embodiment, the mixing/kneading blade 342 is attached by being simply engaged with a noncircular section at an upper end of the blade attachment shaft (blade rotation shaft) 43 which is supported at the center of the bottom of the bread container 340 and is sealed against leakage.

The blade attachment shaft 343 is coupled to the drive shaft 316 and receives power transmitted therefrom. In order to attain the power transmission, a coupling member 344 is fixed to a lower end of the blade attachment shaft 343, while a coupling member 345 to be coupled to the coupling member 344 is fixed to an upper end of the drive shaft 316. The coupling members 344 and 345 are accommodated in the pedestal 341 and in the bread container support 315. It should be noted that the operation of mounting the bread container 340 onto the bread container support 315 (operation for attaining the above-mentioned bayonet coupling) simultaneously establishes coupling between the coupling members 344 and 345.

An elevator (lifting part) 360 is disposed inside the body 310. A lifting motor 361 powers the elevator 360, so that the elevator moves up and down along a guide column 362 extending in a vertical direction. The elevator 360 supports a casing (holding part) 363 via a horizontal support shaft 364 so that the casing 363 may be turned in a vertical plane. Inside the casing 363, a grinding motor 370 and a grinding shaft (rotation shaft) 371 coupled to an axis of the grinding motor 370 are held. The grinding shaft 371 protrudes from the casing 363 at the tip, to which a grinding blade 372 is fixed.

A sheathing 373 surrounds the grinding shaft 371 at the portion protruding outside the casing 363 and the grinding blade 372. The sheathing 373 is a rotational body made of a sheet metal such as a stainless steel plate, and shaped like a part of an eggshell.

An attitude changer 366 for changing an attitude of the casing 363 along with the movement of the elevator 360 is disposed in a movement path of the casing 363. The attitude changer 366 is formed of a rod hanging down from a tip end of a bracket 365 fixed to an upper end of the guide column 362. A protruding portion 363a is formed at an end portion of the casing 363. The protruding portion 363a has an inclined surface which comes into contact with a lower end of the attitude changer 366.

A control device 380 illustrated in FIG. 47 controls an operation of the automatic bread maker 300A. The control device 380 is formed a circuit board disposed in an appropriate place inside the body 310 (similarly as in the case of the first embodiment). The control device 380 is connected to the console part 320 and the heating device 331, and is further connected to a motor driver 381 for the mixing/kneading motor 350, to a motor driver 382 for the lifting motor 361, to a motor driver 383 for the grinding motor 370, and to a temperature sensor 384. The temperature sensor 384 is disposed inside the baking chamber 330, and detects temperature of the baking chamber 330. A commercial power source 385 supplies power to each constituent element. It should be noted that, in the case where the shielding lid 330a is provided to the baking chamber 330, a closing device (for example, motor) for closing the baking chamber 330 by moving the shielding lid 330a may be controlled by the control device 380.

The automatic bread maker 300A configured as described above is also capable of making bread from grains, similarly to the automatic bread maker 1A of the first embodiment, by following the breadmaking processes according to the first to third aspects (see FIGS. 10 to 18). In the following, an operation of making bread from grains by using the automatic bread maker 300A is described, mainly focusing on the difference from the first embodiment.

In the pre-grinding impregnation process #10 (see FIG. 11), operations of measuring the grains and the liquid in Steps #11 and #12 are basically similar to those in the first embodiment. In the following, the points of difference in Steps #11 and #12 are described.

When the automatic bread maker 300A is used, the bread container 340 may be taken out from the baking chamber 330 through the door 311 (see FIG. 43) which is opened, so that grains and a liquid may be put into the bread container 240. Alternatively, grains and a liquid may be put into the bread container 340 placed inside the baking chamber 330, through the door 211 opened. At this time, the elevator 360 is set in an ascent position as illustrated in FIGS. 42 and 43. The protruding portion 363a of the casing 363 is brought into contact with the attitude changer 364, so that the casing 363 maintains an attitude in which the grinding shaft 371 is kept in a horizontal position. This attitude is referred to as retraction position of the casing 363.

When grains and a liquid are put into the bread container 340 inside the baking chamber 330, or when the bread container 340, which contains grains and a liquid put thereinto outside the baking chamber 330, is installed into the baking chamber 330, the door 311 is closed. Following Step #12, Step #13 for still standing and Step #14 for checking time are performed similarly as in the first embodiment.

Following the pre-grinding impregnation process #10, the grinding process #20 (see FIG. 12) is started after a preparatory operation (of inputting data on the grinding operation and pressing the start key) similar to that of the first embodiment. However, unlike in the case of the first embodiment, the control device 380 drives the lifting motor 361 to move down the elevator 360, before starting the rotation of the grinding blade 372. It should be noted that, when the shielding lid 330a is provided to the baking chamber 330, the shielding lid 330a is moved beforehand to clear the upper surface of the baking chamber 330 before moving down the elevator 360.

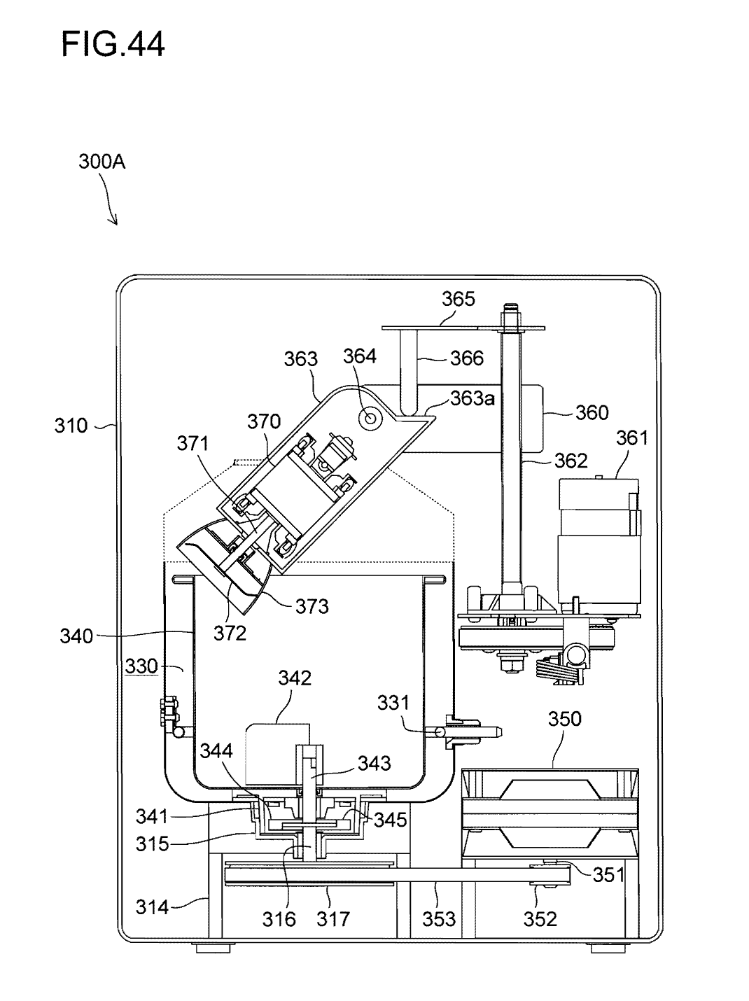

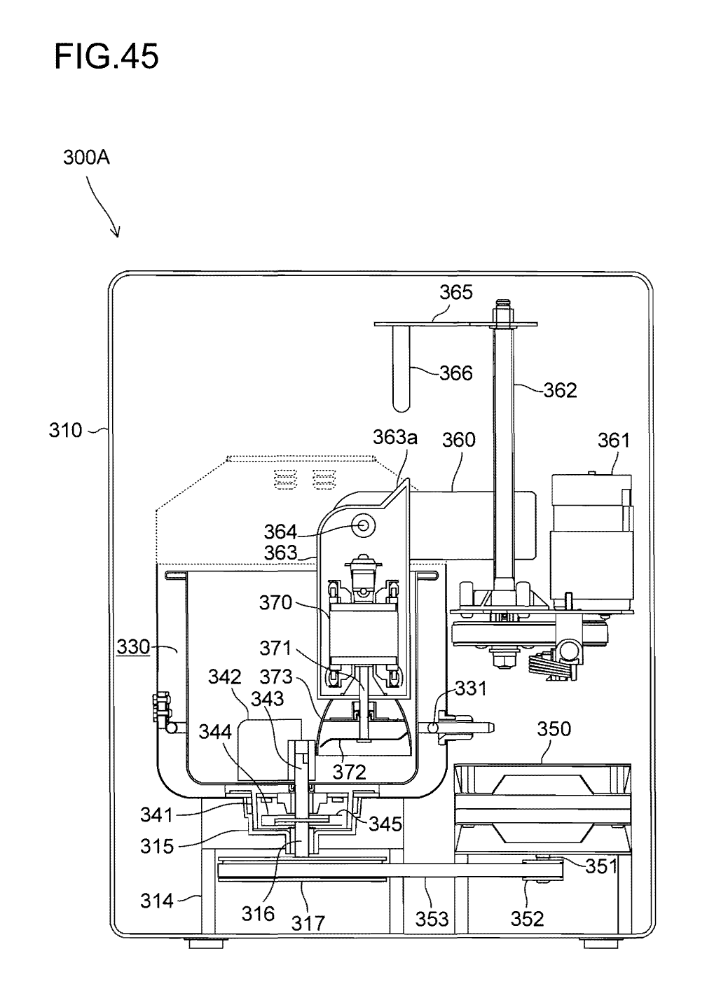

Along with the downward movement of the elevator 360, the casing 363 is tilted in a slanting direction as illustrated in FIG. 44, and then turned into a vertical attitude illustrated in FIG. 45. The elevator 360 continues to move down even after the casing 363 is turned into a vertical attitude, so that the grinding blade 372 is brought to a position (grinding position) close to the bottom of the bread container 340 at a predetermined distance. At this time, the mixing/kneading blade 342 is turned in advance to a direction of avoiding contact with the grinding blade 372 and the sheathing 373. Alternatively, an origin position of the mixing/kneading blade 342 may be set to a position of avoiding contact with the sheathing 373, and the mixing/kneading blade 342 may be configured to always stop at the origin position after rotation.

In Step #21, the control device 380 drives grinding motor 370, to thereby rotate the rotation shaft 371. In this manner, the grinding blade 372 starts rotation in the mixture of the grains and the liquid. The grains to be ground by the grinding blade 372 are impregnated beforehand with the liquid, and therefore the grains may be easily ground to the core.

In the manner as described above, during the rotation of the grinding blade 372, the grains in the bread container 340 go into the sheathing 373 together with the liquid through a gap between the sheathing 373 and the inner bottom surface of the bread container 340 to be ground by the grinding blade 372, and go out of the sheathing 373, in a repetitive manner, so that the grains are ground down into small pieces.

It should be noted that Step #22 for checking whether or not the set grinding pattern is carried through and Step #23 for stopping rotation of the grinding blade 372 are performed similarly as in the case of the first embodiment. However, in the automatic bread maker 300A, the following operation is performed after the rotation operation of the grinding blade 372.

Specifically, when the rotation of the grinding blade 372 is ended, the elevator 360 is moved up to a position illustrated in FIGS. 42 and 43. Along with the upward movement of the elevator 360, the casing 363 changes its attitude so that the grinding shaft 371 is turned into a horizontal position from a vertical position, and is eventually settled in the retraction position of FIGS. 42 and 43. It should be noted that, when the shielding lid 330a is provided to the baking chamber 330, the shielding lid 330a is moved along with the movement of the casing 363 to the retraction point, so that the upper surface of the baking chamber 330 is closed.

The mixing/kneading process #30 (FIG. 13), the fermentation process #40 (FIG. 14), and the baking process #50 (FIG. 15) are sequentially performed following the grinding process #20, in the same manner as in the first embodiment. Further, the operation in the post-grinding impregnation process #60 (FIG. 17) in the bread making process according to the second and third aspects is similarly performed as in the first embodiment.

It should be noted that, in the cases of the bread making processes according to the first and third aspects, the breadmaking operation may be configured in a fully automated manner so that each process to the baking process #50 as the last process is automatically performed in sequence once the start key is pressed after the setting of grains and a liquid is completed in the pre-grinding impregnation process #10. Further, in the case of the breadmaking process according to the second aspect, the breadmaking operation may be configured in a fully automated manner that each process to the baking process #50 as the last process is automatically performed in sequence once the start key is pressed after the setting of grains and a liquid is completed in the grinding process #20. Those configurations apply to the automatic bread makers 100 and 200 according to the second and the third embodiment.

It should be noted that the fourth embodiment is similar to the second and third embodiments in that the grinding blade 372 may be used for a purpose other than grinding grains (such as, for pulverizing fillings such as nuts into small particles, or for pulverizing foodstuffs and herbal medicines other than the fillings to be mixed into bread). Further, the fourth embodiment is also similar to the first, second and third embodiments in that the rotation of the grinding blade 372 and the rotation of the mixing/kneading blade 342 may be controlled in association with each other by the single control device 380 so that the quality of the bread is improved.

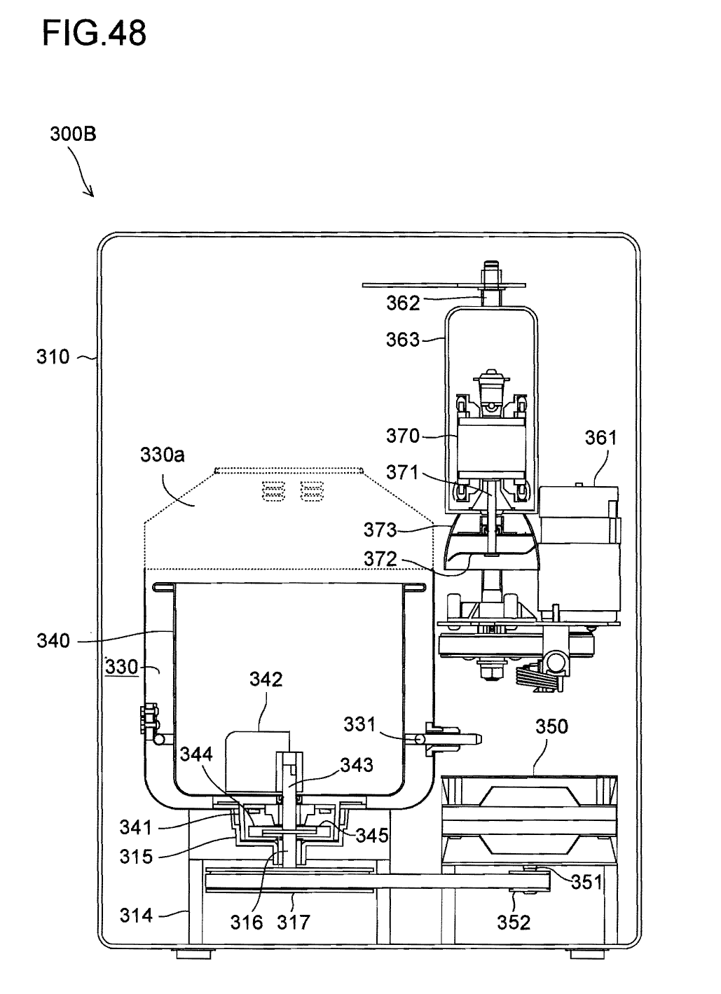

Next, with reference to FIGS. 48 to 55, a modified example of the fourth embodiment of the present invention is described. In the modified example of the fourth embodiment, constituent elements which are the same as those of the fourth embodiment are denoted by the same reference symbols used in the fourth embodiment, and the description thereof is omitted.

The modified example of the fourth embodiment is different from the fourth embodiment in terms of configuration of the elevator 360 and the casing 363. Specifically, the casing 363 according to the modified example of the fourth embodiment is integrally formed with the elevator 360 and fixed to a vertical position (see, for example, FIGS. 48, 50, and 52). Further, as illustrated in FIGS. 48 to 51, the elevator 360 is configured to be turned in a horizontal plane with respect to the guide column 362, and the elevator 360 is turned by a power source (for example, motor) (not shown), so that the casing 363 is turned in a horizontal plane.

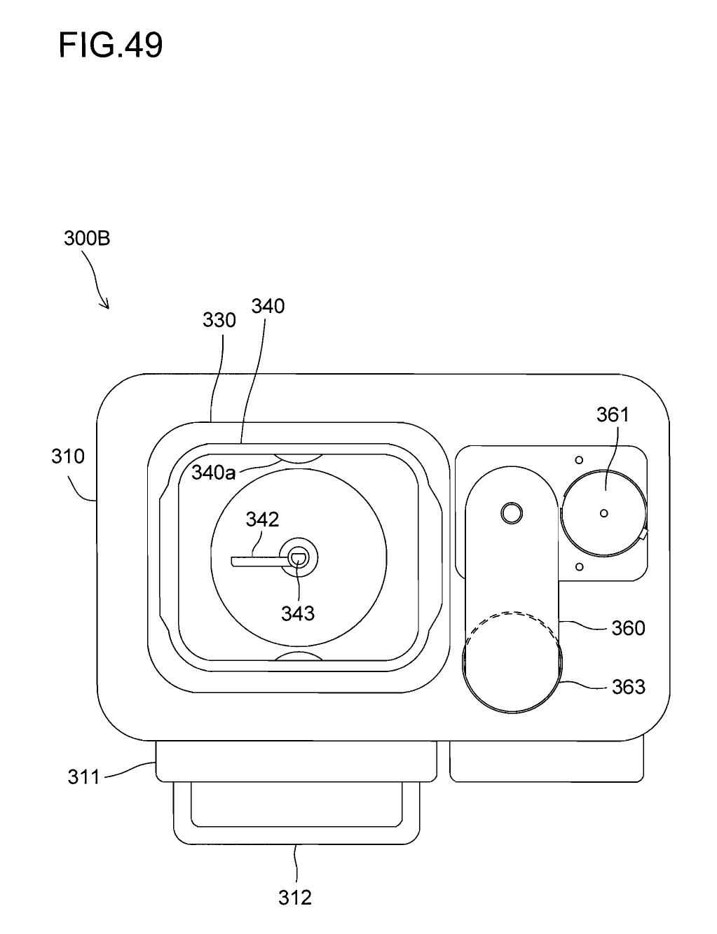

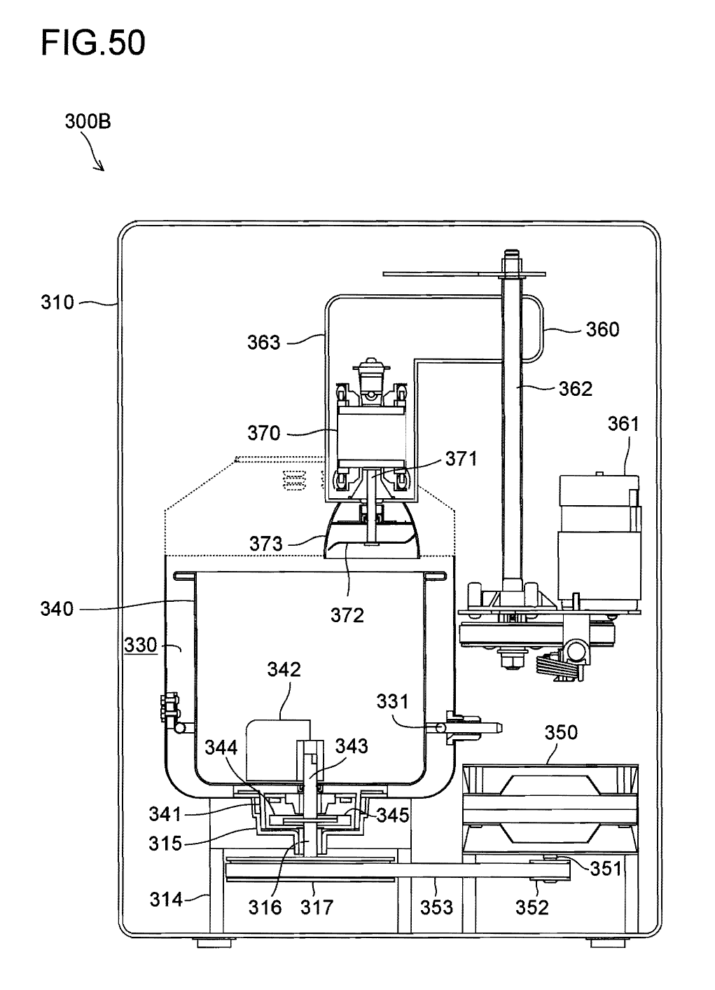

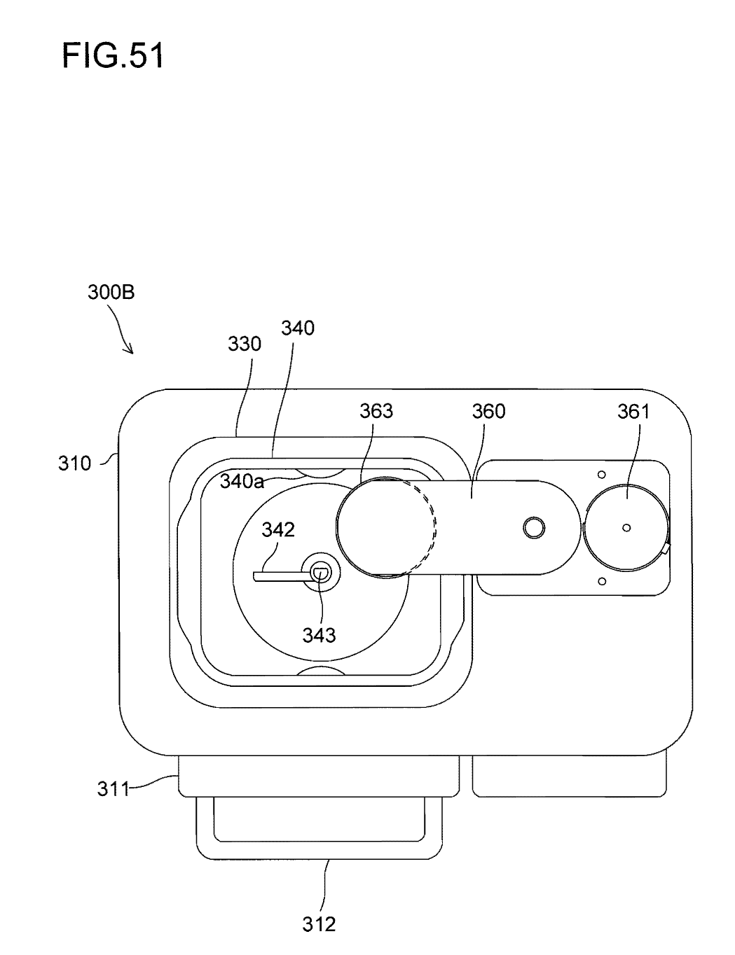

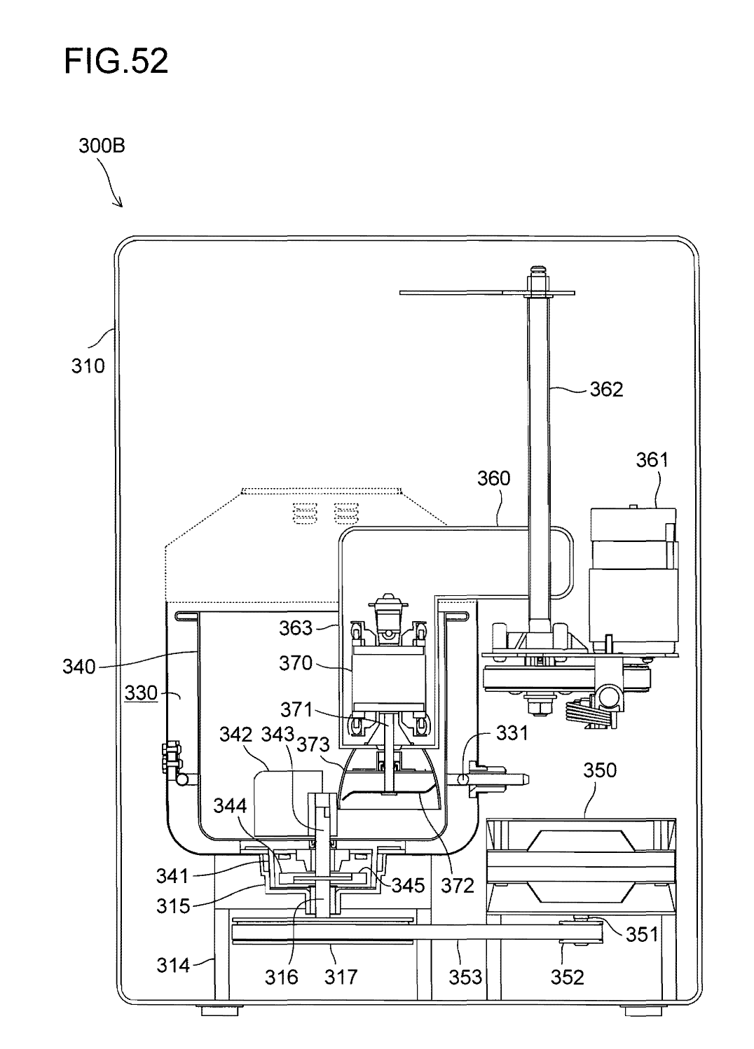

FIGS. 48 and 49 each illustrate a state in which the grinding process #20 is yet to be performed. The elevator 360 is placed in the ascent position, and the casing 363 is turned to a position to be cleared away from the above of the bread container 340. This position serves as a retraction position of the casing 363 holding the grinding motor 370 and the grinding shaft 371 (which has the grinding blade 372 at the tip). When the grinding process #20 is started, the elevator 360 turns 90 degrees as illustrated in FIGS. 50 and 51, so that the casing 363 is turned to a position facing the bread container 340. After that, the elevator 360 is moved down, to thereby bring the grinding blade 372 to a position (grinding position) close to the bottom of the bread container 340 at a predetermined distance (state illustrated in FIG. 52). Similarly to the fourth embodiment, the mixing/kneading blade 342 is turned in advance to a direction of avoiding contact with the grinding blade 372 and the sheathing 373.

After the grinding is completed and the grinding motor 370 is stopped, the elevator 360 moves up to a height as illustrated in FIG. 50. When the casing 363 and the sheathing 373 come out of the bread container 340, the elevator 360 turns to a position as illustrated in FIGS. 48 and 49, and the casing 363 is turned to the retraction position.

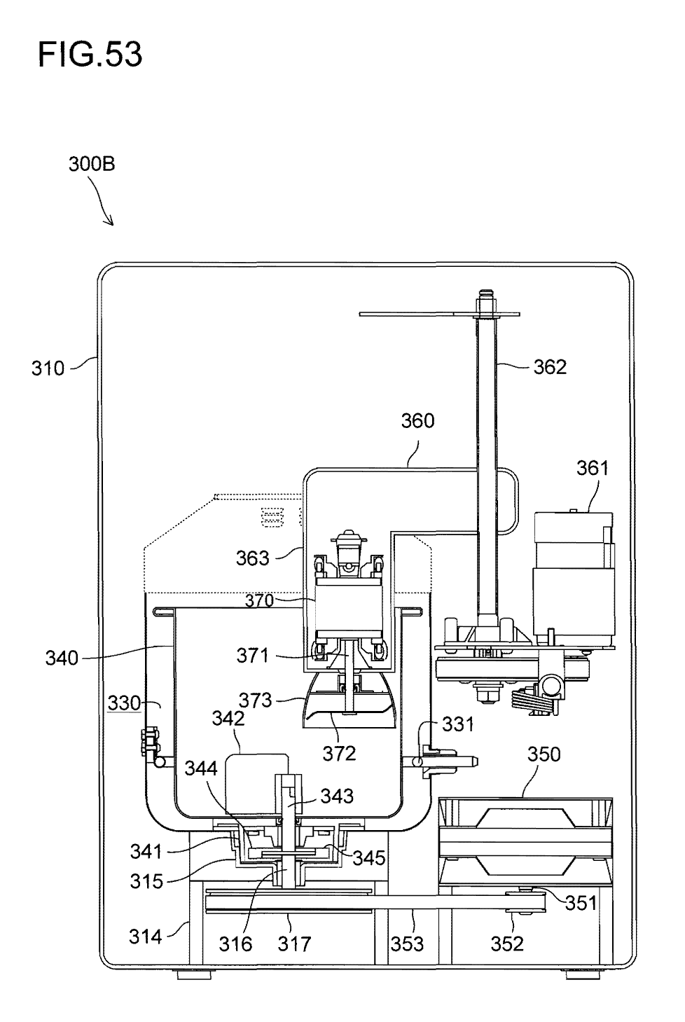

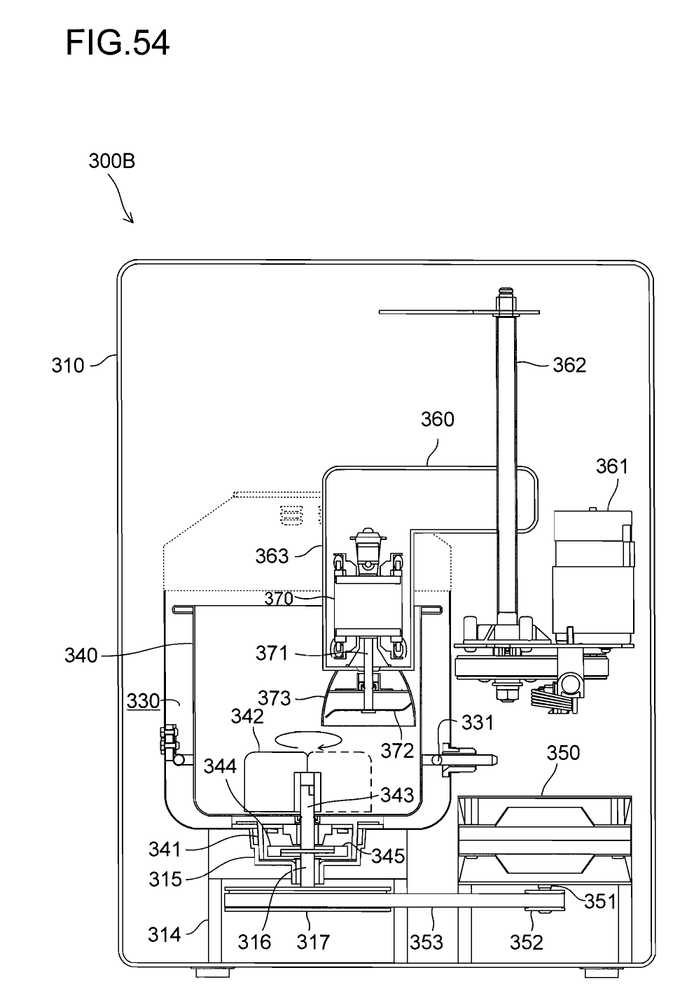

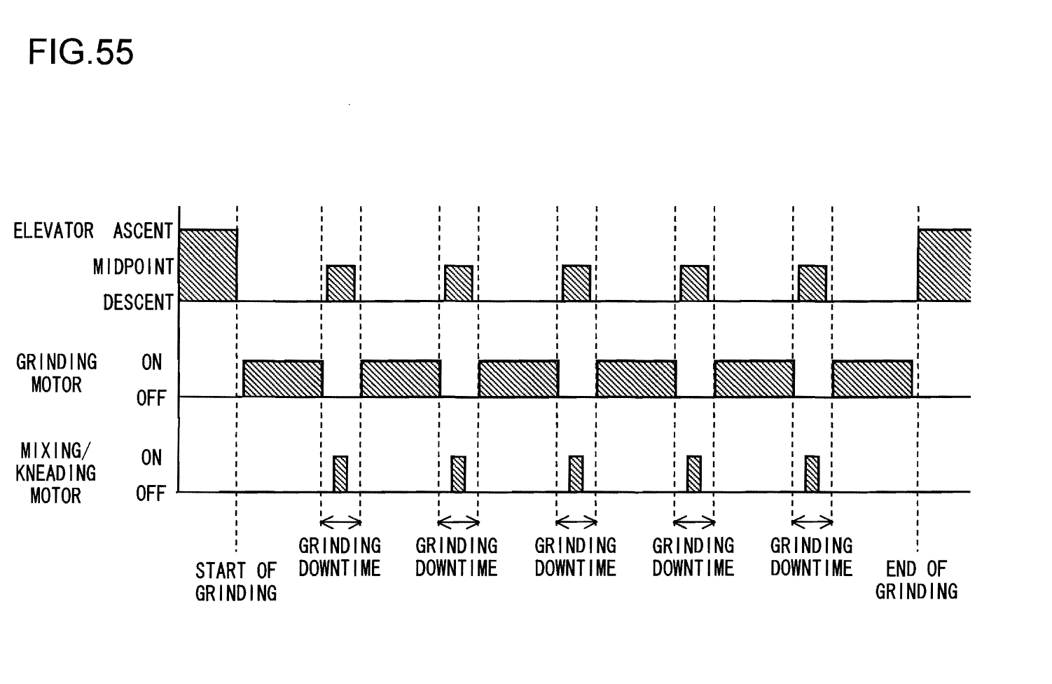

In the grinding process #20, the control device 380 controls the elevator 360 (lifting motor 361), the grinding motor 370, and the mixing/kneading motor 350, according to the chart of FIG. 55. Specifically, first, the elevator 360 is moved down and the grinding motor 370 is turned ON to start grinding. Then, after a lapse of a predetermined time, the grinding motor 370 is turned OFF to start a grinding downtime. During the grinding downtime, the control device 380 moves the elevator 360 up to an intermediate position between the ascent position and the descent position as illustrated in FIGS. 53 and 54, and then rotates the mixing/kneading blade 342. The grinding blade 372 and the sheathing 373 are pulled up sufficiently higher than the mixing/kneading blade 342, and hence the mixing/kneading blade 342 does not come in contact therewith during the rotation.

The mixing/kneading blade 342 is stopped after being rotated for a predetermined duration in time. The elevator 360 is moved down to a position illustrated in FIG. 52 and the grinding downtime is ended. Then, the grinding is re-started. After the first grinding period, the above-mentioned cycle of the grinding down-period and the grinding period is repeated several times, to thereby complete the grinding process #20. For example, the time setting may be made in the following manner. That is, the grinding downtime may be set to 10 seconds (or to a longer time of, for example, 5 minutes) and the grinding period may be set to 60 seconds (or to a shorter time of, for example, 30 seconds), and the cycle of the grinding downtime and the grinding time is repeated six to seven times (or more times as 10 times) after the first grinding period.

When grinding is performed, the grains being ground are increased in temperature due to friction heat generated between the grinding blade 372 and the grains and the heat generated by the grinding motor 370 which is conducted through the grinding shaft 371. If no countermeasures are taken, the grains are likely to be heated up to high temperature inappropriate for breadmaking. In view of this, the grinding downtime is provided as describe above, so that the heat generated by the grinding is dissipated during the grinding downtime, with the result that the grinding operation may be performed without excessively increasing the temperature of the grains being ground. Further, during the grinding downtime, the elevator 360 is moved up to a position capable of allowing the mixing/kneading blade 342 to rotate without coming into contact with the sheathing 373, and the mixing/kneading blade 342 rotates in this state to stir the grains. As a result, the grains are ground to be uniform in grain size.

It should be noted that the above-mentioned grinding method may be employed, not only in the modified example of the fourth embodiment, but also in the fourth embodiment.

Further, in the case of the modified example of the fourth embodiment, the retraction position of the casing 363 is located outside the baking chamber 330 but medially in the body 310. Accordingly, there is no need to provide the door 311 anteriorly to the body 310 in order to take out the baked bread, and may be configured to allow the bread to be taken out from the upper surface of the body 310.

In the above, the embodiments of the present invention have been described. However, the scope of the present invention is not limited thereto, and the present invention may be implemented by being subjected to various modifications without departing from the gist of the present invention.

What is claimed is:

1. An automatic bread maker which sequentially performs a mixing/kneading process, a fermentation process, and a baking process, the automatic bread maker comprising:
a bread container used for accommodating breadmaking materials;
a baking chamber which is provided inside a body and receives the bread container;
a grinding blade which is capable of being put into and taken out of the bread container in the baking chamber; and
a grinding motor provided for rotating the grinding blade.

2. An automatic bread maker according to claim 1, further comprising a lid for covering the baking chamber,
wherein, in a state in which the bread container is disposed inside the baking chamber and the baking chamber is covered with the lid, the grinding blade is provided to a tip end of a rotation shaft hanging down inside the bread container from the lid.

3. An automatic bread maker according to claim 2,
wherein the grinding motor, which rotates the rotation shaft, is incorporated in a motor case which is insertable into the lid from above, and
wherein the rotation shaft and the grinding blade hang down from a lower surface of the motor case, and are capable of being pulled out, along with the motor case, from the lid.

4. An automatic bread maker according to claim 2,
wherein the grinding motor, which rotates the rotation shaft, is incorporated in the lid, and
wherein the rotation shaft and the grinding blade form a grinding blade assembly, which is coupled to the grinding motor in a detachable manner.

5. An automatic bread maker according to claim 4, wherein the lid is capable of being lifted up from the body and turned in a lift up state.

6. An automatic bread maker according to claim 1, further comprising:
a rotation shaft provided with the grinding blade at a lower end thereof; and
a mixing kneader surrounding the grinding blade and the rotation shaft,
wherein, in a state in which the bread container is disposed inside the baking chamber, the rotation shaft and the mixing kneader hang down inside the bread container from above.

7. An automatic bread maker according to claim 6, wherein the mixing kneader includes a dough kneading part in a dorm shape surrounding the grinding blade and a dough turning part in a form of a rotational body provided above the dough kneading part.

8. An automatic bread maker according to claim 6, further comprising a lifting part for supporting the rotation shaft and the mixing kneader, the lifting part being provided inside the automatic bread maker,
wherein the lifting part moves up and down, to thereby allow the rotation shaft and the mixing kneader to be alternately switched between a state in which the rotation shaft and the mixing kneader are disposed inside the bread container and a state in which the rotation shaft and the mixing kneader are pulled out from the bread container.

9. An automatic bread maker according to claim 1, further comprising:
a rotation shaft which is provided with the grinding blade at a lower end thereof and hangs down from above the baking chamber; and
a lifting part for moving up the bread container in the baking chamber to a grinding position where the grinding blade is brought close to a bottom of the bread container.

10. An automatic bread maker according to claim 9,
wherein the bread container has a mixing/kneading blade disposed at the bottom thereof, and
wherein the baking chamber has a drive shaft disposed at a bottom thereof, the drive shaft being coupled to the mixing/kneading blade when the bread container is disposed at the bottom of the baking chamber.

11. An automatic bread maker according to claim 1, further comprising:
a rotation shaft provided with the grinding blade at one end thereof; and
a lifting part for supporting the grinding motor and the rotation shaft,
wherein the lifting part moves up and down, to thereby allow the grinding blade and the rotation shaft to be alternately moved to a grinding position where the grinding blade is brought close to a bottom of the bread container disposed in the baking chamber and a retraction position where the grinding blade is retracted outside the bread container disposed in the baking chamber.

12. An automatic bread maker according to claim 11,
wherein the lifting part moves up and down in a vertical direction, and
wherein the rotation shaft is placed in a horizontal direction as being in the retraction position.

13. An automatic bread maker according to claim 12, further comprising:
a holding part for holding the grinding motor and the rotation shaft;
a support shaft for supporting the holding part with respect to the lifting part so that the rotation shaft is allowed to be turned freely between the vertical direction and the horizontal direction;
a protruding portion formed at a top of the holding part; and
an attitude changer for changing an attitude of the holding part along with the lifting part moving up and down, in coordination with the protruding portion.

14. An automatic bread maker according to claim 11, wherein the retraction position is set to a position retracted to clear a space above the bread container.

15. An automatic bread maker according to claim 14, further comprising a lifting shaft extending in the vertical direction for guiding the lifting part which moves up and down,
wherein the lifting part is turnable in a horizontal plane, with respect to the lifting shaft.

16. An automatic bread maker according to claim 11,
wherein the bread container has a mixing/kneading blade disposed at the bottom thereof, and
wherein the baking chamber has a drive shaft disposed at a bottom thereof, the drive shaft being coupled to the mixing/kneading blade when the bread container is disposed at the bottom of the baking chamber.

17. An automatic bread maker according to claim 16, further comprising a control device for controlling a lifting motor for moving the lifting part up and down, the grinding motor, and a mixing/kneading motor for rotating the drive shaft,
wherein the control device performs control so that a rotation of the grinding blade is stopped to provide a grinding downtime during a grinding process which is performed by rotating the grinding blade.

18. An automatic bread maker according to claim 17, wherein the control device performs control, during the grinding downtime, so that the lifting part is moved up, before rotating the mixing/kneading blade, to a position of allowing the mixing/kneading blade to rotate without one of coming into contact with the grinding blade and the rotation shaft or coming into contact with an outer body surrounding the grinding blade and the rotation shaft, and the mixing/kneading blade is rotated in this state.

19. An automatic bread maker according to claim 17, further comprising:
a shielding lid for shielding an opening of the baking chamber; and
a closing part for closing the baking chamber by moving the shielding lid,
wherein the closing part is controlled by the control device.
